(19) United States
(12) Patent Application Publication
(10) Pub. No.: US 2026/0186699 A1
(43) Pub. Date: Jul. 2, 2026

(54) DATA PROCESSING DEVICE FOR CONVOLUTION PROCESSING

(71) Applicant: MegaChips Corporation, Osaka (JP)

(72) Inventor: Mahito MATSUMOTO, Osaka (JP)

(73) Assignee: MegaChips Corporation, Osaka (JP)

(21) Appl. No.: 19/546,474

(22) Filed: Feb. 23, 2026

Related U.S. Application Data
(63) Continuation of application No. PCT/JP2024/036254, filed on Oct. 10, 2024.

(30) Foreign Application Priority Data
Dec. 1, 2023 (JP) 2023-203692

(51) Int. Cl. G06F 3/06

(52) U.S. Cl. CPC G06F 3/0655; G06F 3/0604; G06F 3/0673

(57) ABSTRACT

Provided is a data processing device for convolution processing that can perform data processing for achieving a high-performance, high-speed CNN model, which reduces the number of times the processing of reading feature data is performed and shortens the time required for the entire convolution processing including the processing of reading feature data. In the data processing device for convolution processing, (1) each of the multiple bank memories Tmem_k in the memory circuitry is provided with multiple access buses, allowing simultaneous (parallel) access to data for multiple channels, and (2) different (independent) bank memories Tmem_k are assigned to each height direction of the region to be subjected to convolution processing (the region to be convolved with the kernel), thus allowing simultaneous (parallel) access to multiple data in different height directions.

### CROSS-REFERENCE TO RELATED APPLICATIONS

The present application is a continuation of International Patent Application No. PCT/JP2024/036254, filed on Oct. 10, 2024, which claims priority to Japanese Patent Application No. 2023-203692, filed on Dec. 1, 2023, each are incorporated herein by reference in their entirety.

### TECHNICAL FIELD

The present invention relates to a data processing technology for a convolutional neural network, and more particularly to a technology for processing feature data used in a convolutional neural network (a data processing device for convolutional processing).

### BACKGROUND ART

In recent years, technologies using neural network models has been attracting attention as it can achieve a wide variety of applications with high accuracy. In technologies using a neural network model, learning processing of the neural network model is performed using learning data, a trained model is obtained, and a prediction processing (inference processing) is performed using the obtained trained model. This allows technologies using neural network models to achieve a wide variety of applications with high accuracy. As a technology using a neural network model that has achieved high value in fields such as image recognition, a technology using a convolutional neural network model (CNN) has been attracting attention.

Further, lightweighting technologies are being developed to enable convolutional neural network models to be used on devices such as mobile devices that do not have abundant computing resources. As such a technology, for example, a technology called Mobilenet (a technology for making CNN models lightweight) has been developed (see, for example, Non-Patent Document 1).

A technology called Mobilenet (a technology for making CNN models lightweight) reduces the number of parameters in CNN models by adopting a technique called depthwise separable convolution, which divides normal convolution processing into (1) depthwise convolution (convolution processing in the spatial direction) and (2) pointwise convolution (convolution processing in the channel direction). This allows for achieving a lightweight, high-performance CNN model that can be installed in mobile devices that do not have abundant computing resources.

### Prior Art Documents

### Non-Patent Documents

Non-Patent Document 1: Howard, Andrew G., et al. “MobileNets: Efficient Convolutional Neural Networks for Mobile Vision Applications.” arXiv preprint arXiv:1704.04861 (2017).

### DISCLOSURE OF INVENTION

### Technical Problem

However, in the above-described conventional technology (Mobilenet), it is necessary to frequently read out feature data, and the time required for the feature data read processing is longer than the time required for the product-sum calculation for the convolution processing, resulting in a longer time required for the CNN processing. In other words, with the above-described conventional technology (Mobilenet), even if the processing (convolution processing) of the CNN calculation itself is accelerated, the time required for the processing to read feature data becomes a bottleneck (critical path), making it difficult to shorten the time required for the total processing (CNN processing) including the processing to read feature data.

In view of the above-described problems, an object of the present invention is to provide a data processing device for convolution processing that can reduce the number of times feature data reading processing is performed, shorten the time required for the entire convolution processing including the feature data reading processing, and perform data processing to achieve a high-performance, high-speed CNN model.

### Solution to Problem

To solve the above problems, a first aspect of the present invention provides a data processing device for convolution processing used in a convolutional neural network model, including a plurality of bank memories for storing feature data, and an access control unit for controlling data writing and/or data reading from the plurality of bank memories.

The feature data is three-dimensional data specified by a position in a width direction, a position in a height direction, and a position in a channel direction.

Each of the plurality of bank memories has a plurality of access buses so as to be able to access data in parallel.

The access control circuitry performs data write control so that the feature data whose position in the height direction is a first value is stored in a bank memory allocated to the first value among the plurality of bank memories, and further stores the plurality of feature data having the same position in the width direction and consecutive positions in the channel direction in memory areas at addresses accessible in parallel via the plurality of buses.

In the data processing device for convolution processing, (1) each of the multiple bank memories Tmem_k in the memory circuitry is provided with multiple access buses, allowing simultaneous (parallel) access to data for multiple channels, and (2) different (independent) bank memories Tmem_k are assigned to each height direction of the region to be subjected to convolution processing (the region to be convolved with the kernel), thus allowing simultaneous (parallel) access to multiple data in different height directions.

The “feature data” may be feature data after quantization processing.

A second aspect of the present invention provides the data processing device for convolution processing of the first aspect of the present invention in which the access control circuitry performs data read control on the plurality of bank memories so that the feature data having the same position in the width direction and consecutive positions in the height direction are read for a plurality of channels in a read unit period.

This allows the convolution processing data device to read out data for multiple channels of h×1 (h rows, 1 column, h: position in the height direction) from the region to be subjected to convolution processing during one data read processing period (a read unit period).

A third aspect of the present invention provides the data processing device for convolution processing of the first or second aspect of the present invention in which assuming that a data group obtained by reading the feature data, which are at the same position in the width direction and have consecutive positions in the height direction, for a plurality of channels from the plurality of bank memories is a multi-channel h×1 data group, the access control circuitry obtains the number of overlapping multi-channel h×1 data groups as the number of output systems in the same read unit period depending on the position of the region to be subjected to convolution processing, and controls the multiple bank memories so that the multiple channel h×1 data groups equal to the obtained number of output systems are outputted from the multiple bank memories.

The convolution processing data device obtains the number of output systems Num_sys, which is the number of overlapping data sets (h×1 data sets in the region to be subjected to convolution processing), depending on the position of the region to be subjected to convolution processing (slid position), and can output the overlapping data sets (h×1 data sets in the region to be subjected to convolution processing) equal to the obtained number of output systems Num_sys, each in separate systems (in parallel).

This allows the convolution processing data device to slide the position of the region to be subjected to convolution processing, thereby reducing the number of times overlapping data is read.

A fourth aspect of the present invention provides the data processing device for convolution processing of the third aspect of the present invention, further including register circuitry capable of storing data by addressing.

The register circuitry inputs the multi-channel h×1 data group outputted from the multiple bank memories, uses a size in the width direction of the kernel of the convolution processing to be performed on the multi-channel h×1 data group as an offset value, and sequentially writes feature data, which are located at consecutive positions in the height direction and are included in the multi-channel h×1 data group, into the memory area of the register circuitry at an address offset by the offset value.

The convolution processing data device includes register circuitry, in which data read from the memory unit is written to discrete addresses (addresses to which a predetermined offset value (corresponding to the size of the kernel in the width direction (for a 3×3 kernel, the offset value is “3”)) is added) according to the size (shape) of the region to be convolution processing (size (shape) of the kernel), and after all of the data (feature data) for the region to be convolution processed has been collected (after all of the data for the region to be convolution processed has been written at consecutive addresses in the register circuitry), all of the data for the region to be convolution processed can be outputted.

This allows the convolution processing data device to output all data in the region to be convolution processed (data to be subjected to convolution processing) as data arranged in the order in which the convolution operation is to be performed, and write the data, for example, to a memory unit for quantized data. Subsequently, the data arranged in the order in which the convolution operation is to be performed is read, for example, from a memory unit for quantized data, and the convolution processing is performed using the kernel weighting coefficient data to be applied to the data, thereby allowing the convolution processing to be performed at high speed.

In this way, in the convolution processing data device, simply providing a functional unit that performs the above processing allows for reducing the number of times that duplicate data is read, while obtaining data arranged in the order in which the convolution operation is to be performed. Thus, the convolution processing data device can perform data processing to achieve a high-performance, high-speed CNN model, which can reduce the number of times the feature data reading processing is performed and shorten the time required for the entire convolution processing including the feature data reading processing.

A fifth aspect of the present invention provides the data processing device for convolution processing of the fourth aspect of the present invention in which after the feature data of the region to be subjected to convolution processing with the kernel is stored in the memory area of the register circuitry at consecutive addresses, the register circuitry outputs the feature data stored in the memory area at the consecutive addresses. In the convolution processing data device, after the feature data of the region to be convolution processed with the kernel has been stored in a memory area of consecutive addresses in the register circuitry, that is, after the feature data that has been stored after being offset by the offset value has been stored in a continuous state (stored in a memory area of consecutive addresses in the register circuitry) rather than in a discrete state, the feature data stored in the memory area of the consecutive addresses is outputted. Thus, in the convolution processing data device, it is possible to ensure that the feature data is outputted from the register circuitry after the feature data of the region to be convolution processed with the kernel has been collected.

A sixth aspect of the present invention provides the data processing device for convolution processing of the fifth aspect of the present invention in which the register circuitry outputs the feature data stored in the memory area of the consecutive addresses all at once or in the order of the consecutive addresses.

Thus, in the convolution processing data device, it is guaranteed that feature data of a region to be convolution processed with a kernel (a plurality of feature data that are to be convolution processed with a kernel (for example, when the kernel is a 3×3 kernel, nine pieces of feature data included in the region to be convolution processed with the kernel) are outputted all at once or in a state arranged in the order in which convolution processing with the kernel is performed (the order in which product-sum calculations of kernel weight coefficient data are performed).

### Advantageous Effects

The present invention provides a data processing device for convolution processing that can reduce the number of times feature data reading processing is performed, shorten the time required for the entire convolution processing including the feature data reading processing, and perform data processing to achieve a high-performance, high-speed CNN model.

### BRIEF DESCRIPTION OF DRAWINGS

FIG. 1 is a schematic configuration diagram of a CNN data processing device 100 according to a first embodiment.

FIG. 2 is a schematic configuration diagram of a CNN data processing unit 2 of the CNN data processing device 100 according to the first embodiment.

FIG. 3 is a diagram for explaining CNN processing (convolution processing for a CNN model) using (1) depthwise convolution (convolution processing in the spatial direction) and (2) pointwise convolution (convolution processing in the channel direction).

FIG. 4 is a diagram for explaining data stored in each bank memory (when there are four bank memories (as an example)) of the CNN data processing unit 2 of the CNN data processing device 100.

FIG. 5 is a diagram for explaining data access to a bank memory of the CNN data processing unit 2 of the CNN data processing device 100.

FIG. 6 is a diagram for explaining the relationship between readout data and blocks when the CNN data processing unit 2 of the CNN data processing device 100 performs data read processing.

FIG. 7 is a diagram for explaining the relationship between readout data and blocks when the CNN data processing unit 2 of the CNN data processing device 100 performs data read processing.

FIG. 8 is a flowchart of CNN data processing performed by the CNN data processing device 100.

FIG. 9 is a flowchart of CNN data processing performed by the CNN data processing device 100.

FIG. 10 is a flowchart of CNN data processing performed by the CNN data processing device 100.

FIG. 11 is a timing chart of data write processing and data read processing of the CNN data processing unit 2 of the CNN data processing device 100.

FIG. 12 is a diagram for explaining data access to a bank memory of the CNN data processing unit 2 of the CNN data processing device 100.

FIG. 13 is a diagram for explaining data read processing from a bank memory of the CNN data processing unit 2 of the CNN data processing device 100.

FIG. 14 is a diagram for explaining data read processing from a bank memory of the CNN data processing unit 2 of the CNN data processing device 100.

FIG. 15 is a diagram for explaining data read processing from a bank memory of the CNN data processing unit 2 of the CNN data processing device 100.

FIG. 16 is a timing chart of the data read processing of the CNN data processing unit 2 of the CNN data processing device 100.

FIG. 17 is a timing chart of the data read processing of the CNN data processing unit 2 of the CNN data processing device 100.

FIG. 18 is a diagram for explaining the relationship between readout data, blocks, and data write addresses of a register unit 23 when data read processing is performed in the CNN data processing unit 2 of the CNN data processing device 100.

FIG. 19 is a diagram for explaining the relationship between readout data, blocks, and data write addresses of the register unit 23 when data read processing is performed in the CNN data processing unit 2 of the CNN data processing device 100.

FIG. 20 is a diagram for explaining the relationship between readout data, blocks, and data write addresses of the register unit 23 when data read processing is performed in the CNN data processing unit 2 of the CNN data processing device 100.

FIG. 21 is a diagram for explaining the relationship (including the relationship for channels 0 to 4) between readout data, blocks, and data write addresses of the register unit 23 when data read processing is performed in the CNN data processing unit 2 of the CNN data processing device 100.

FIG. 22 is a diagram showing a CPU bus configuration.

### DESCRIPTION OF EMBODIMENTS

### First Embodiment

The first embodiment will be described below with reference to the drawings.

### 1.1: Configuration of CNN Data Processing Device

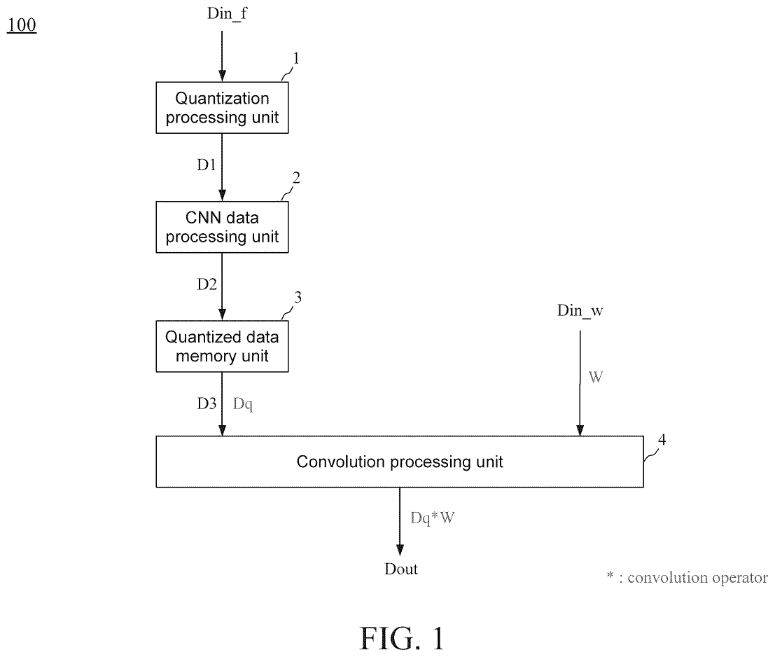

FIG. 1 is a schematic diagram of a CNN data processing device 100 according to a first embodiment.

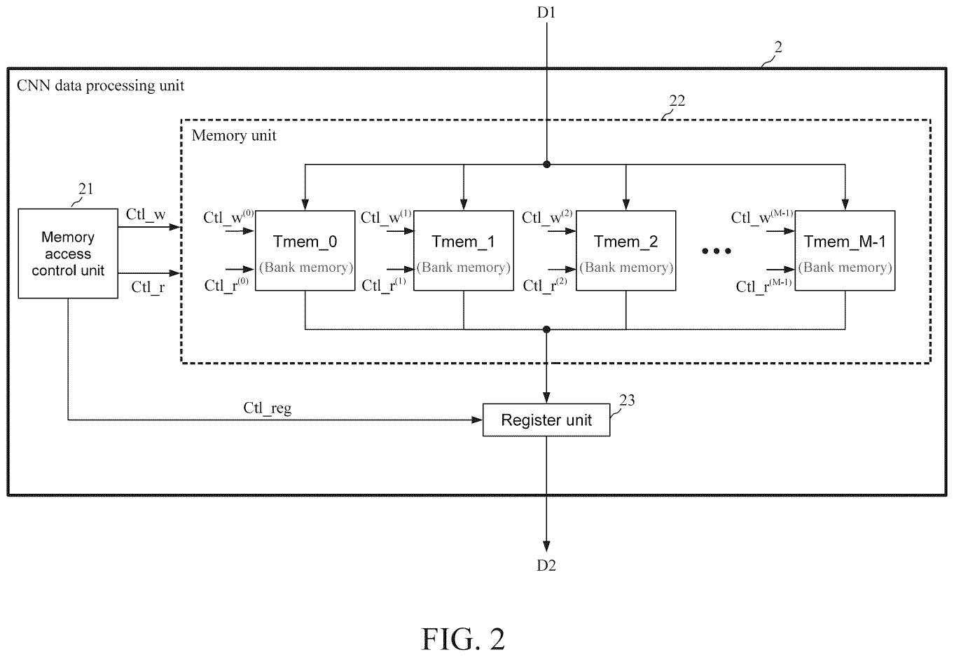

FIG. 2 is a schematic configuration diagram of a CNN data processing unit 2 of the CNN data processing device 100 according to the first embodiment.

As shown in FIG. 1, the CNN data processing device 100 includes a quantization processing unit 1, a CNN data processing unit 2 (convolution processing data device), a quantized data memory unit 3, and a convolution processing unit 4. The CNN data processing device 100 receives feature data Din_f and weighting coefficient data Din_w (weighting filter (kernel)), performs convolution processing (convolution processing using the feature data and weighting coefficient data), and obtains (transmits) processing result data Dout of the convolution processing.

The quantization processing unit 1 receives the feature data Din_f, performs quantization processing on the feature data Din_f, and then transmits the quantized data to the CNN data processing unit 2 as data D1.

As shown in FIG. 2, the CNN data processing unit 2 includes a memory access control unit 21, a memory unit 22 including M (M is a natural number) bank memories (Tmem_0 to Tmem_M-1), and a register unit 23.

The memory access control unit 21 is a control unit for performing access control (data write processing control, data read processing control) to the M bank memories of the memory unit 22. The memory access control unit 21 is a functional unit for independently (in parallel) controlling data write processing and data read processing for the M bank memories Tmem_0 to Tmem_M-1 of the memory unit 22. The memory access control unit 21 transmits a control signal Ctl_w for controlling data write processing and/or a control signal Ctl_r for controlling data read processing to the memory unit 22. Specifically, the memory access control unit 21 transmits a control signal Ctl_w^{(k)} for controlling data write processing and/or a control signal Ctl_r^{(k)}for controlling data read processing to the bank memory Tmem_k (k is a natural number satisfying 0≤k≤M-1) of the memory unit 22. Note that the control signal Ctl_w for controlling the data write processing for the bank memory Tmem_k (k is a natural number satisfying 0≤k≤M-1) of the memory unit 22 is represented as the control signal Ctl_w^{(k)}, and the control signal Ctl_r for controlling the data read processing for the bank memory Tmem_k of the memory unit 22 is represented as the control signal Ctl_r^{(k)}.

The memory access control unit 21 is a control unit for performing access control (data write processing control, data read processing control) for the register unit 23. The memory access control unit 21 transmits a control signal Ctl_reg to the register unit 23 for controlling access to the register unit 23.

As shown in FIG. 2, the memory unit 22 includes M (M is a natural number) bank memories Tmem_0 to Tmem_M-1.

The bank memory Tmem_k (k is a natural number satisfying 0≤k≤M-1) is a memory that can write specified data to a specified address of the bank memory Tmem_k and read the data stored at that address from the specified address of the bank memory Tmem_k. In accordance with the control signal Ctl_w^{(k)} for data writing processing from the memory access control unit 21, the bank memory Tmem_k writes the data D1 transmitted from the quantization processing unit 1 to the address of the bank memory Tmem_k specified by the control signal Ctl_w^{(k)}. In addition, the bank memory Tmem_k reads data stored at the address of the bank memory Tmem_k specified by the control signal Ctl_w^{(k)} in accordance with the control signal Ctl_r^{(k)} for data read processing from the memory access control unit 21, and then transmits the readout data to the register unit 23.

The register unit 23 has a memory (register) that can write data to a specified area by specifying an address, and can read data stored in a specified area by specifying an address. The register unit 23 receives the data transmitted from the memory unit 22 and the control signal Ctl_reg transmitted from the memory access control unit 21. The register unit 23 writes the data transmitted from the memory unit 22 to a specified address in the register unit 23 in accordance with the control signal Ctl_reg. Further, the register unit 23 transmits data at a specified address in the register unit 23 as data D2 to the quantized data memory unit 3 in accordance with the control signal Ctl_reg.

The quantized data memory unit 3 has a memory capable of storing data, and the memory can write data to a specified area by specifying an address, and can also read data stored in a specified area by specifying an address. The quantized data memory unit 3 receives the data D2 transmitted from the CNN data processing unit 2 and then stores the data D2. In addition, the quantized data memory unit 3 transmits the stored data to the convolution processing unit 4 as data D3 (the quantized data memory unit 3 receives a data readout command from the control unit (not shown) or the convolution processing unit 4, and transmits data at a specified address to the convolution processing unit 4 as data D3 in accordance with the data readout command).

The convolution processing unit 4 receives the weighting coefficient data Din_w (weighting filter (kernel)) and the data D3 transmitted from the quantized data memory unit 3. The convolution processing unit 4 performs convolution processing using the data D3 and the weighting coefficient data Din_w, and then transmits the data after convolution processing as data Dout.

### 1.2: Operation of CNN Data Processing Device

The operation of the CNN data processing device 100 configured as above will be described below.

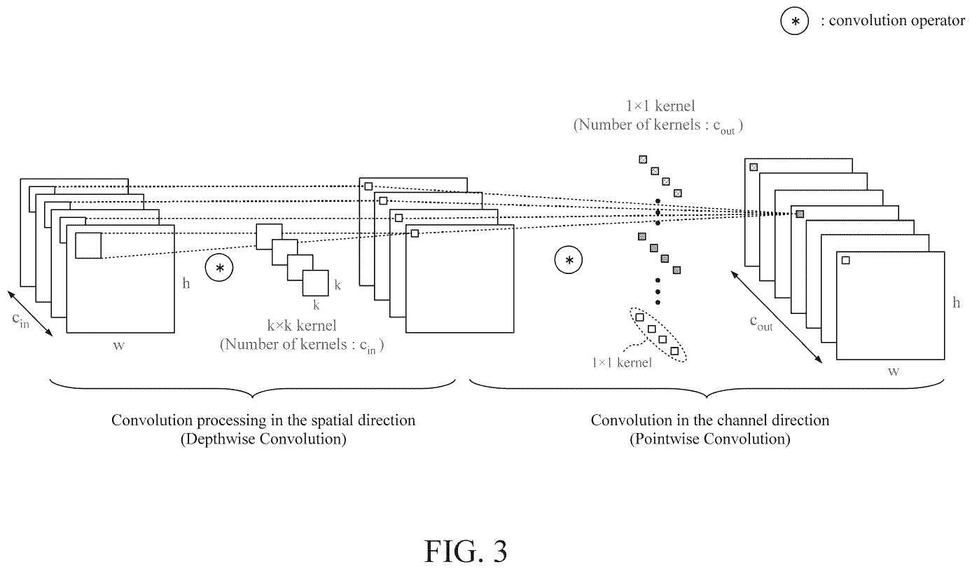

FIG. 3 is a diagram for explaining CNN processing (convolution processing for a CNN model) using (1) depthwise convolution (convolution processing in the spatial direction) and (2) pointwise convolution (convolution processing in the channel direction).

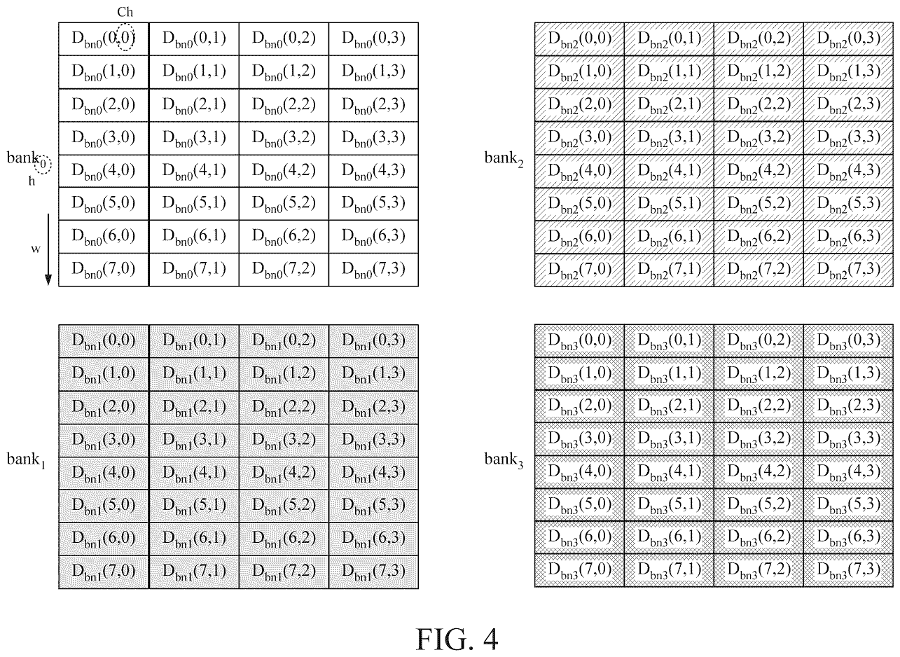

FIG. 4 is a diagram for explaining data stored in each bank memory (for example, when there are four bank memories) of the CNN data processing unit 2 of the CNN data processing device 100.

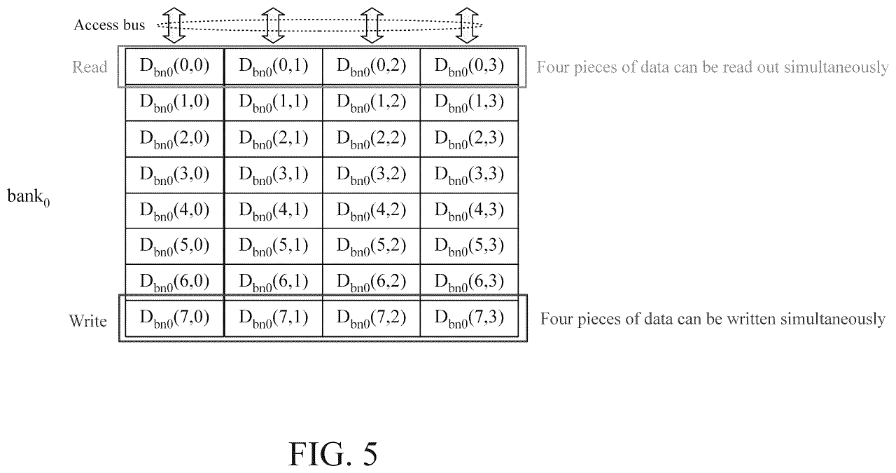

FIG. 5 is a diagram for explaining data access to the bank memory of the CNN data processing unit 2 of the CNN data processing device 100.

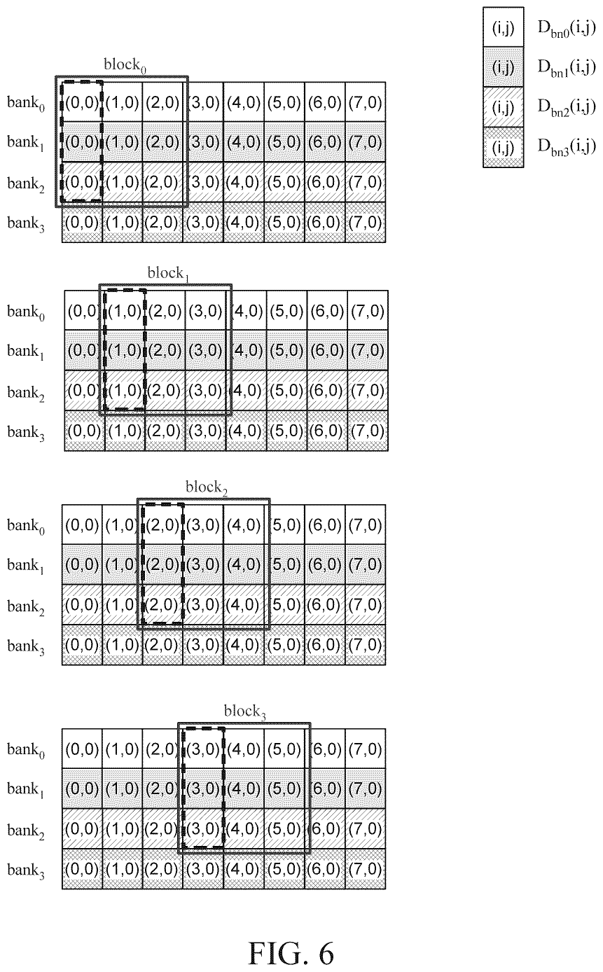

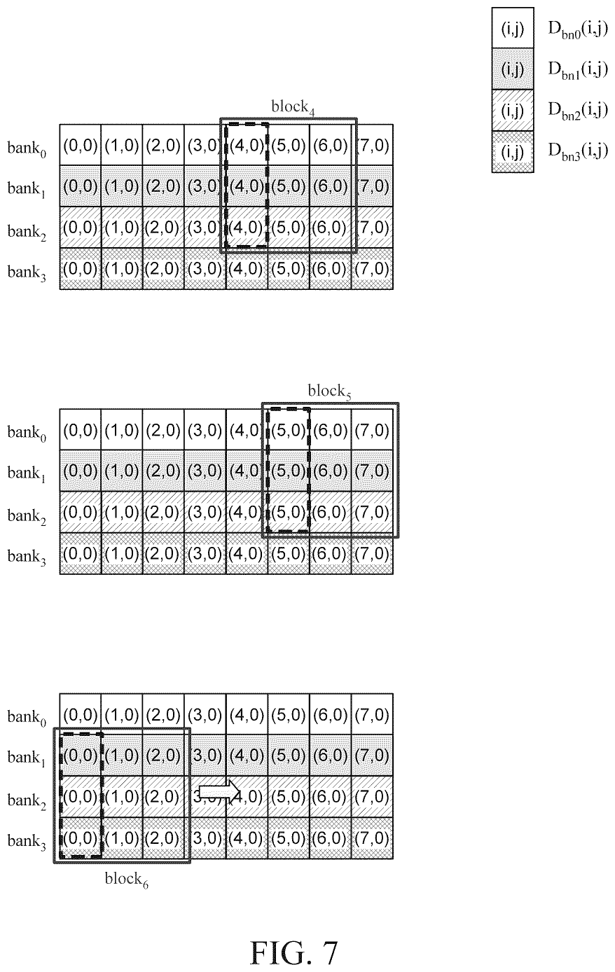

FIGS. 6 and 7 are diagrams for explaining the relationship between readout data and blocks when the CNN data processing unit 2 of the CNN data processing device 100 performs data read processing.

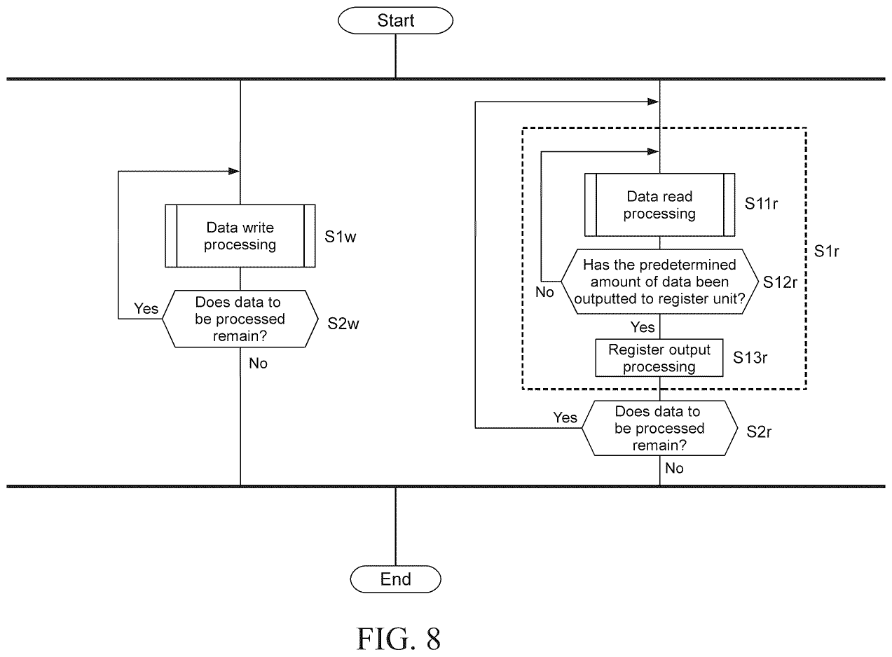

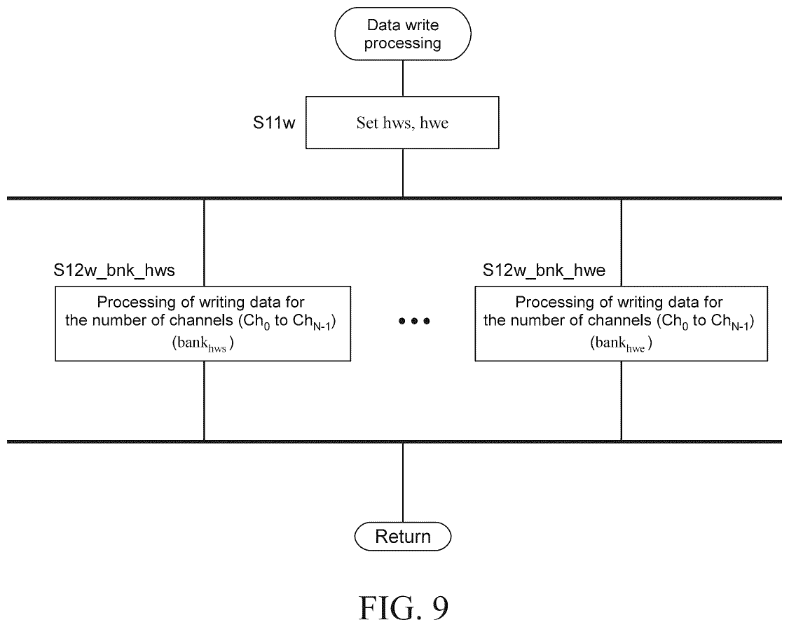

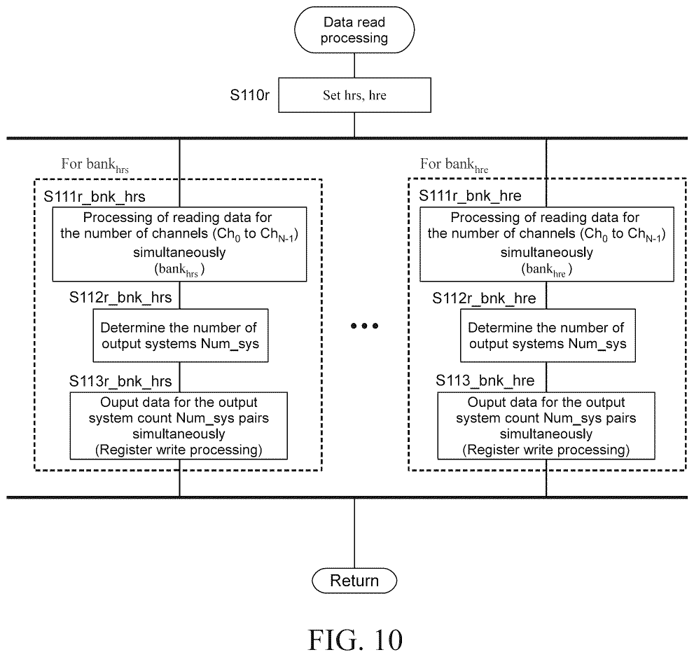

FIGS. 8 to 10 are flowcharts of the CNN data processing performed by the CNN data processing device 100.

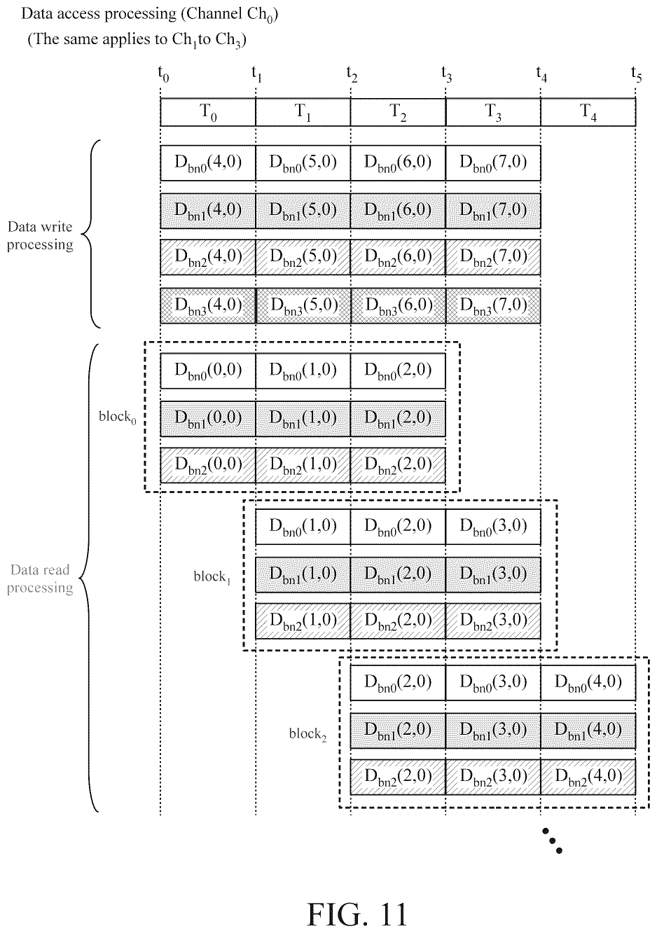

FIG. 11 is a timing chart of the data write processing and data read processing of the CNN data processing unit 2 of the CNN data processing device 100.

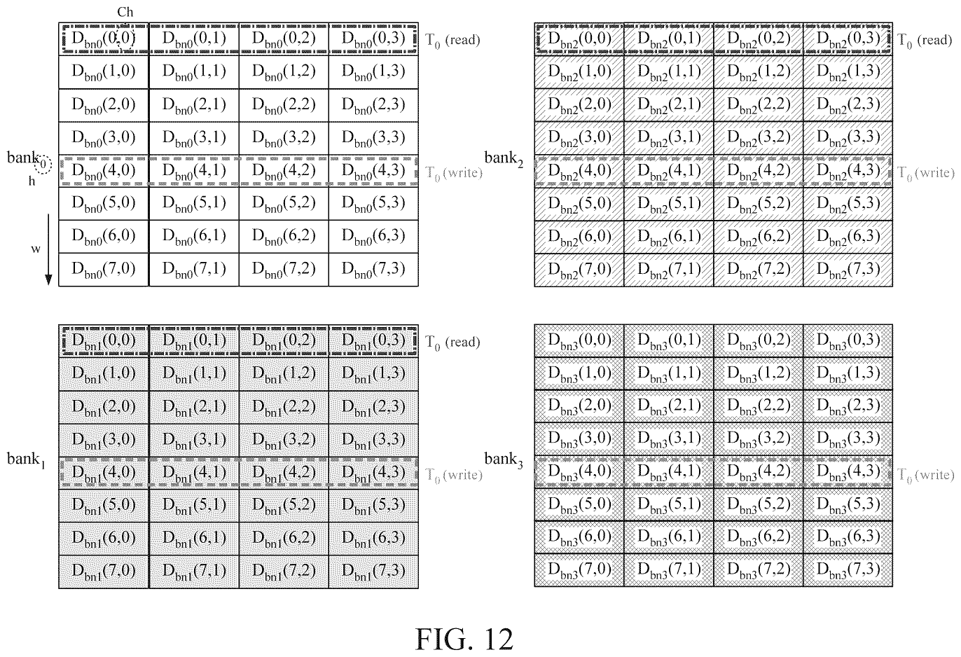

FIG. 12 is a diagram for explaining data access to the bank memory of the CNN data processing unit 2 of the CNN data processing device 100.

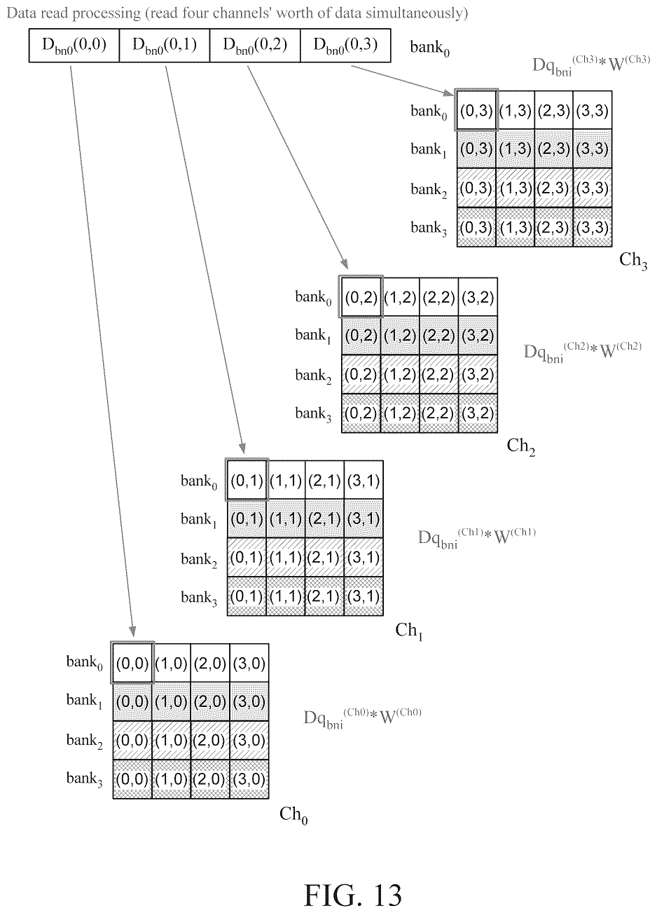

FIGS. 13 to 15 are diagrams for explaining the data read processing from the bank memory of the CNN data processing unit 2 of the CNN data processing device 100.

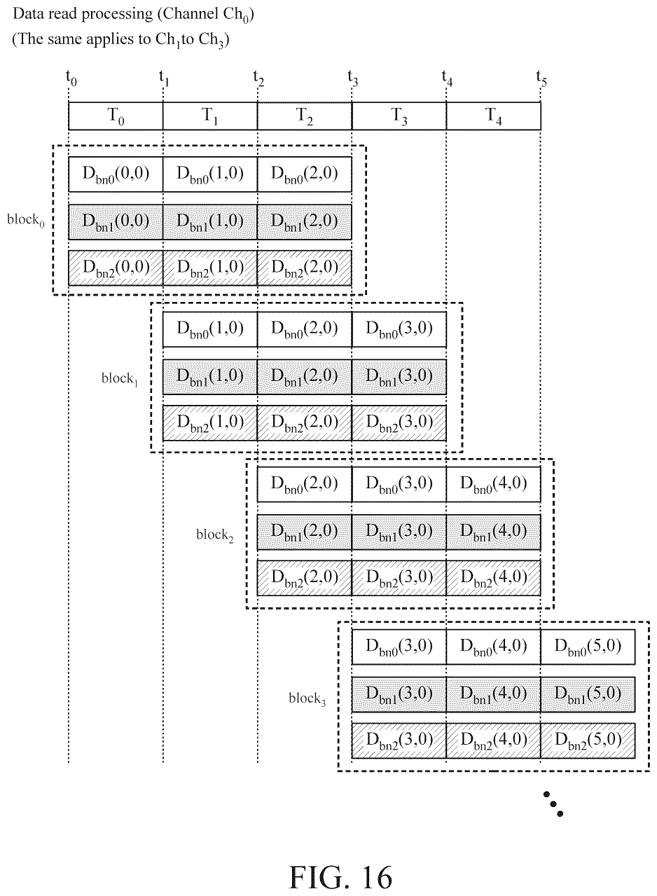

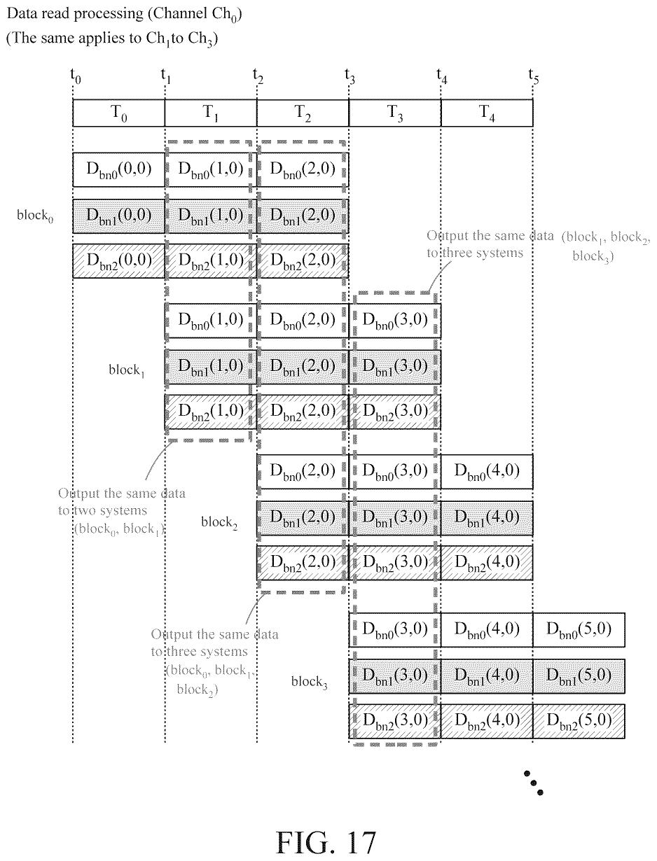

FIGS. 16 and 17 are timing charts of the data read processing of the CNN data processing unit 2 of the CNN data processing device 100.

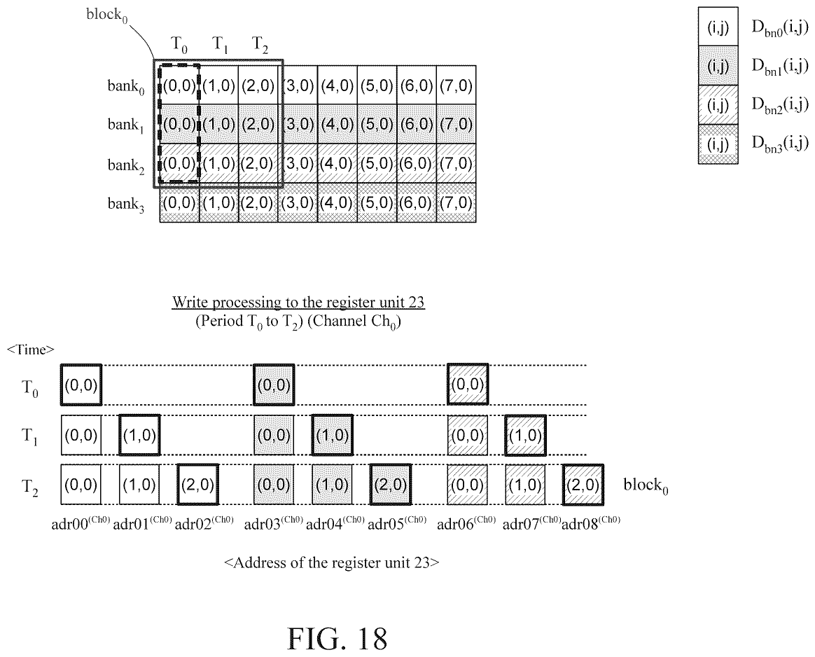

FIGS. 18 to 20 are diagrams for explaining the relationship between readout data, blocks, and data write addresses of the register unit 23 when data read processing is performed in the CNN data processing unit 2 of the CNN data processing device 100.

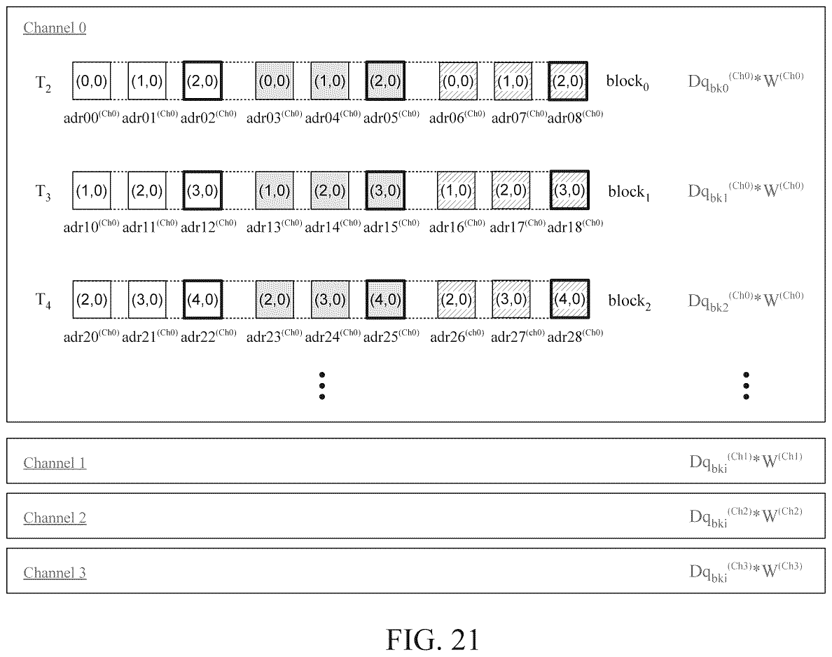

FIG. 21 is a diagram for explaining the relationship (including the relationship for channels 0 to 4) between the readout data, blocks, and data write addresses of the register unit 23 when data read processing is performed in the CNN data processing unit 2 of the CNN data processing device 100.

As shown in FIG. 3, when a method is adopted in which normal convolution processing is divided into two parts, namely (1) depthwise convolution (convolution processing in the spatial direction) and (2) pointwise convolution (convolution processing in the channel direction), the time required for the feature data read processing is longer than the time required for the product-sum calculation for the convolution processing in depthwise convolution (convolution processing in the spatial direction), and as a result, the time required for performing the CNN processing is longer. To address this issue, in the CNN data processing device 100, the CNN data processing unit 2 (A) performs data write processing for N (N is a natural number of 2 or greater) channels (Ch₀ to Ch_{N-1}) in parallel, and (B) performs data read processing for N (N is a natural number of 2 or greater) channels (Ch₀ to Ch_{N-1}) in parallel. Further, in the CNN data processing device 100, the CNN data processing unit 2 simultaneously reads out N channels of data from each of the M bank memories Tmem_0 to Tmem_M-1, and performs in parallel processing in which the same number of data as the number of systems depending on the kernel of the CNN processing is simultaneously transmitted.

For convenience of explanation, the operation of the CNN data processing device 100 will be described below in the following case (one example). The settings for the CNN data processing device 100 should not be limited to the following settings, and other settings may also be used.
(1) The number of channels N for the feature data to be subjected to the convolution processing (feature data inputted into the CNN data processing device 100) is “4” (N=4, channels Ch₀ to Ch₃).
(2) The number of bank memories in the memory unit 22 of the CNN data processing unit 2 is “4” (M=4, bank memories Tmem_0 to Tmem_3 (bank₀ to bank₃)).
(3) As shown in FIG. 4, the bank memory Tmem_k (bankₖ) (k is a natural number satisfying 0≤k≤M−1 (M=4)) of the memory unit 22 of the CNN data processing unit 2 can store 8×4 (8 rows and 4 columns) data (32 pieces of data), and the data stored at the address of row i and column j of the bank memory Tmem_k (bankₖ) is represented as D_{bnk}(i, j) (i, j are natural numbers satisfying 0≤i≤7, 0≤j≤N−1 (N=4)) (i corresponds to the position in the width direction of the feature data (feature map), j corresponds to the channel (position in the channel direction) of the feature data (feature map), and k corresponds to the position in the height direction of the feature data (feature map).
(4) As shown in FIG. 5, the bank memory Tmem_k (bankₖ) of the memory unit 22 of the CNN data processing unit 2 has an access bus that can simultaneously access data in the same row, and can perform data read processing and data write processing independently (in parallel) on data in different rows of the bank memory Tmem_k (bankₖ). (In the case of FIG. 5, data read processing is performed on the data D_{bn0}(0,0) to D_{bn0}(0,3) in the 0th row of the bank memory Tmem_0 (bank₀), and at the same time (in parallel) data write processing is performed on the data D_{bn0}(7,0) to D_{bn0}(7,3) in the 7th row.)
(5) The size of the kernel (weighting coefficient filter) for depthwise convolution (convolution processing in the spatial direction) is 3×3 (the weighting coefficients of the kernel are expressed as a 3×3 matrix).
(6) The region (feature map) to be filtered with the kernel (the region to be subjected to convolution processing) is a 4×8 region (4×8 feature data) as shown in FIGS. 5 and 6, the stride of the convolution processing is “1”, and there is no padding. In other words, the region to be subjected to the convolution processing is determined by shifting the region to which the 3×3 kernel filter is applied, from block₀, block₁, block₂, block₃, block₄, block₅, block₆, . . . in FIGS. 5 and 6.

The feature data Din_f is inputted into the quantization processing unit 1.

The quantization processing unit 1 performs quantization processing on the feature data Din_f, and transmits the quantized data to the CNN data processing unit 2 as data D1.

As shown in FIG. 8, the CNN data processing unit 2 performs, in parallel, (1) data write processing (data write processing for data of N channels (Ch₀ to Ch_{N-1} (N=4 in the present embodiment)) to the bank memory Tmem_k (bankₖ) of the memory unit 22 of the CNN data processing unit 2), and (2) data read processing (data read processing for data of N channels (Ch0 to ChN-1 (N=4 in the present embodiment)) from the bank memory Tmem_k (bankₖ) of the memory unit 22 of the CNN data processing unit 2).

Here, the processing of the CNN data processing unit 2 will be described with reference to the flowcharts of FIGS. 8 to 10.

### Step S1w:

In step S1w, the CNN data processing unit 2 performs data writing processing. For example, as shown in FIGS. 11 and 12, in a case in which during a period T₀ (a period from time t₀ to t₁), the quantization processing unit 1 transmits data D1 including the following data of (1) to (4) to the CNN data processing unit 2, the CNN data processing unit 2 performs processing described below.
(1) Data D_{bn0}(4,0), D_{bn0}(4,1), D_{bn0}(4,2), D_{bn0}(4,3)
(2) Data D_{bn1}(4,0), D_{bn1}(4,1), D_{bn1}(4,2), D_{bn1}(4,3)
(3) Data D_{bn2}(4,0), D_{bn2}(4,1), D_{bn2}(4,2), D_{bn2}(4,3)
(4) Data D_{bn3}(4,0), D_{bn3}(4,1), D_{bn3}(4,2), D_{bn3}(4,3)
(Data D_{bnh}(i, j) indicates data for which the position in the width direction of channel Chⱼ is i and the position in the height direction is h.)

In the above data, the position in the height direction h is 0 to 3, and thus the bank memories to be written to are set to bank0 to bank3. Thus, in the CNN data processing unit 2, the variable hws (variable specifying the starting bank memory to be written) and the variable hwe (variable specifying the ending bank memory to be written) that specify the bank memory to be written are set to hws=0 and hwe=3 (hws, hwe: natural numbers, 0≤hws≤M-1, 0≤hwe≤M-1, hws<hwe) (step S11w).

### Step S12w_bnk_hws:

In step S12w_bnk_hws, processing of writing data for the number of channels (Ch₀ to Ch_{N-1}) into the bank memory bank_{hws} (bank memory Tmem_hws) (hws=0) is performed. Specifically, the following processing is performed.
(1) During the period T₀ (the period from time t₀ to t₁), the memory access control unit 21 of the CNN data processing unit 2 outputs a control signal Ctl_w⁽⁰⁾ to the bank memory Tmem_0 to instruct the memory unit 22 to write the four pieces of data D_{bn0}(4,0), D_{bn0}(4,1), D_{bn0}(4,2), and D_{bn0}(4,3) in parallel (using four access buses (see FIG. 5)) to consecutive addresses of the bank memory Tmem_0 (bank memory bank_{hws}, hws=0). In accordance with the control signal Ctl_w⁽⁰⁾, the bank memory Tmem_0 of the memory unit 22 then writes the four pieces of data D_{bn0}(4,0), D_{bn0}(4,1), D_{bn0}(4,2), and D_{bn0}(4,3) in parallel (using four access buses) to consecutively addressed areas of the bank memory Tmem_0 of the memory unit 22 (see FIG. 12).

### Steps S12w_bnk_1, S12w_bnk_2:

In steps S12w_bnk_1 and S12w_bnk_2, processing of writing data for the number of channels (Ch₀ to Ch_{N-1}) is performed in the bank memories bank₁ and bank₂ (bank memories Tmem_1 and Tmem_2), respectively. Specifically, the following processing is performed.
(2) During the period T₀ (the period from time t₀ to t₁), the memory access control unit 21 of the CNN data processing unit 2 outputs a control signal Ctl_w⁽¹⁾ to the bank memory Tmem_1 to instruct the memory unit 22 to write the four pieces of data D_{bn1}(4,0), D_{bn1}(4,1), D_{bn1}(4,2), and D_{bn1}(4,3) in parallel (using four access buses (see FIG. 5)) to consecutive addresses of the bank memory Tmem_1 (bank memory bank1). In accordance with the control signal Ctl_w⁽¹⁾, the bank memory Tmem_1 of the memory unit 22 then writes the four pieces of data D_{bn1}(4,0), D_{bn1}(4,1), D_{bn1}(4,2), and D_{bn1}(4,3) in parallel (using four access buses) to consecutively addressed areas of the bank memory Tmem_1 of the memory unit 22 (see FIG. 12).
(3) During the period T₀ (the period from time t₀ to t₁), the memory access control unit 21 of the CNN data processing unit 2 outputs a control signal Ctl_w⁽²⁾ to the bank memory Tmem_2 to instruct the memory unit 22 to write the four pieces of data D_{bn2}(4,0), D_{bn2}(4,1), D_{bn2}(4,2), and D_{bn2}(4,3) in parallel (using four access buses (see FIG. 5)) to consecutive addresses of the bank memory Tmem_2 (bank memory bank₂). In accordance with the control signal Ctl_w⁽²⁾, the bank memory Tmem_2 of the memory unit 22 then writes the four pieces of data D_{bn2}(4,0), D_{bn2}(4,1), D_{bn2}(4,2), and D_{bn2}(4,3) in parallel (using four access buses) to consecutively addressed areas of the bank memory Tmem_2 of the memory unit 22 (see FIG. 12).

### Step S12w_bnk_hwe:

In step S12w_bnk_hwe, processing of writing data for the number of channels (Ch0 to ChN-1) into the bank memory bankhwe (bank memory Tmem_hwe) (hwe=3) is performed. Specifically, the following processing is performed.
(4) During the period T0 (the period from time t0 to t1), the memory access control unit 21 of the CNN data processing unit 2 outputs a control signal Ctl_w(3) to the bank memory Tmem_3 to instruct the bank memory Tmem_3 to write the four pieces of data Dbn3(4,0), Dbn3(4,1), Dbn3(4,2), and Dbn3(4,3) in parallel (using four access buses (see FIG. 5)) to consecutive addresses of the bank memory Tmem_3 (bankhwe, hwe=3) of the memory unit 22. In accordance with the control signal Ctl_w(3), the bank memory Tmem_3 of the memory unit 22 then writes the four pieces of data Dbn3(4,0), Dbn3(4,1), Dbn3(4,2), and Dbn3(4,3) in parallel (using four access buses) to consecutively addressed areas of the bank memory Tmem_3 of the memory unit 22 (see FIG. 12).

The above describes the case where hws=0 and hwe=3 are set and four pieces of data that are consecutive in the height direction of the feature data are written (the case where data is written in parallel to bank memories Tmem_0 to Tmem_3); however, this should not be limited to this configuration. hws and hwe may be set to different values and data may be written in parallel to multiple bank memories specified by hws and hwe. Further, since each of the bank memories Tmem_k (k is a natural number satisfying 0≤k≤M−1) can be accessed independently, for example, the data write processing to the bank memories Tmem_k in the above processing may be performed in parallel.

Further, while the data write processing for the period T₀ (period from time t₀ to t₁) has been described above, the same processing is also performed for (1) a period T₁ (period from time t₁ to t₂), (2) a period T₂ (period from time t₁ to t₂), and (3) a period T₃ (period from time t₂ to t₃) in FIG. 11. In the above cases (1) to (4), the following data is written to the bank memories Tmem_0 (bank₀) to Tmem_3 (bank₀) (see FIG. 12).

(1) Period T₁ (Period From Time t₁ to Time t₂):
Data D_{bn0}(5,0), data D_{bn0}(5,1), data D_{bn0}(5,2), and data D_{bn0}(5,3) are written to the bank memory Tmem_0 (bank₀).
Data D_{bn1}(5,0), data D_{bn1}(5,1), data D_{bn1}(5,2), and data D_{bn1}(5,3) are written to the bank memory Tmem_1(bank₁).
Data D_{bn2}(5,0), data D_{bn2}(5,1), data D_{bn2}(5,2), and data D_{bn2}(5,3) are written to the bank memory Tmem_2 (bank₂).
Data D_{bn3}(5,0), data D_{bn3}(5,1), data D_{bn3}(5,2), and data D_{bn3}(5,3) are written to the bank memory Tmem_3 (bank₃).
   (2) Period T₂ (Period From Time t₂ to time t₃):
Data D_{bn0}(6,0), data D_{bn0}(6,1), data D_{bn0}(6,2), and data D_{bn0}(6,3) are written to the bank memory Tmem_0 (bank₀).
Data D_{bn1}(6,0), data D_{bn1}(6,1), data D_{bn1}(6,2), and data D_{bn1}(6,3) are written to the bank memory Tmem_1(bank₁).
Data D_{bn2}(6,0), data D_{bn2}(6,1), data D_{bn2}(6,2), and data D_{bn2}(6,3) are written to the bank memory Tmem_2 (bank₂).
Data D_{bn3}(6,0), data D_{bn3}(6,1), data D_{bn3}(6,2), and data D_{bn3}(6,3) are written to the bank memory Tmem_3 (bank₃).
   (3) Period T₃ (Period From Time t₃ to Time t₄):
Data D_{bn0}(7,0), data D_{bn0}(7,1), data D_{bn0}(7,2), and data D_{bn0}(7,3) are written to the bank memory Tmem_0 (bank₀).
Data D_{bn1}(7,0), data D_{bn1}(7,1), data D_{bn1}(7,2), and data D_{bn1}(7,3) are written to the bank memory Tmem_1(bank₁).
Data D_{bn2}(7,0), data D_{bn2}(7,1), data D_{bn2}(7,2), and data D_{bn2}(7,3) are written to the bank memory Tmem_2 (bank₂).
Data D_{bn3}(7,0), data D_{bn3}(7,1), data D_{bn3}(7,2), and data D_{bn3}(7,3) are written to the bank memory Tmem_3 (bank₃).

### Step S2w:

In step S2w, it is determined whether or not data to be subjected to the write processing remains in the CNN data processing unit 2, and if data to be subjected to the write processing remains, the process returns to S1w and the same process as above is performed. On the other hand, if no data to be subjected to the write processing remains, the data writing processing in the CNN data processing unit 2 ends.

### Step S1r:

In step S1r, the CNN data processing unit 2 performs data read processing.

For example, as shown in FIGS. 11 and 12, in a case in which, during the period T₀ (the period from time t₀ to t₁), the following data (1) to (3) is read from the memory unit 22 of the CNN data processing unit 2, the CNN data processing unit 2 performs processing below.
(1) Data D_{bn0}(0,0), D_{bn0}(0,1), D_{bn0}(0,2), D_{bn0}(0,3)
(2) Data D_{bn1}(0,0), D_{bn1}(0,1), D_{bn1}(0,2), D_{bn1}(0,3)
(3) Data D_{bn2}(0,0), D_{bn2}(0,1), D_{bn2}(0,2), D_{bn2}(0,3)
(Data D_{bnh}(i, j) indicates data for which the position in the width direction of channel Chj is i and the position in the height direction is h.)

In the above data, the position in the height direction h is 0 to 2, so the bank memory to be read out is set to bank₀ to bank₂ (since the size of the kernel (weighting coefficient filter) for depthwise convolution (spatial convolution processing) is 3×3 and the height size is “3”, the configuration is set in this way). Thus, in the CNN data processing unit 2, the variable hrs (variable specifying the starting bank memory to be read out) and the variable hre (variable specifying the ending bank memory to be read out) that specify the bank memory to be read out are set to hrs=0 and hre=2 (hrs, hre: natural numbers, 0≤hrs≤M−1, 0≤hrs≤M−1, hrs<hre) (step S110r).

Step S111r_bnk_hrs (hrs=0):

In step S111r_bnk_hrs, processing of reading data for the number of channels (Ch₀ to Ch_{N-1}) (N=4) from the bank memory bankₕᵣₛ (bank memory Tmem_hrs) (hrs=0) is performed. Specifically, the following processing is performed.
(1) During the period T₀ (the period from time t₀ to t₁), the memory access control unit 21 of the CNN data processing unit 2 outputs a control signal Ctl_r⁽⁰⁾ to the bank memory Tmem_0 to instruct the memory unit 22 to read four pieces of data, D_{bn0}(0,0), D_{bn0}(0,1), D_{bn0}(0,2), and D_{bn0}(0,3) in parallel (using four access buses (see FIG. 5)) from consecutive address areas of the bank memory Tmem_0 (bank memory bankₕᵣₛ, hrs=0). In accordance with the control signal Ctl_r⁽⁰⁾, the bank memory Tmem_0 of the memory unit 22 then reads out four pieces of data (four channels of data), namely, data D_{bn0}(0,0), D_{bn0}(0,1), D_{bn0}(0,2), and D_{bn0}(0,3) in parallel (using four access buses) from consecutively addressed areas of the bank memory Tmem_0 of the memory unit 22 (see FIG. 12) (see FIG. 13 for the relationship between the four channels of data read out in parallel and the spatial position of the feature data (feature map)).

### Step S111r_bnk_1:

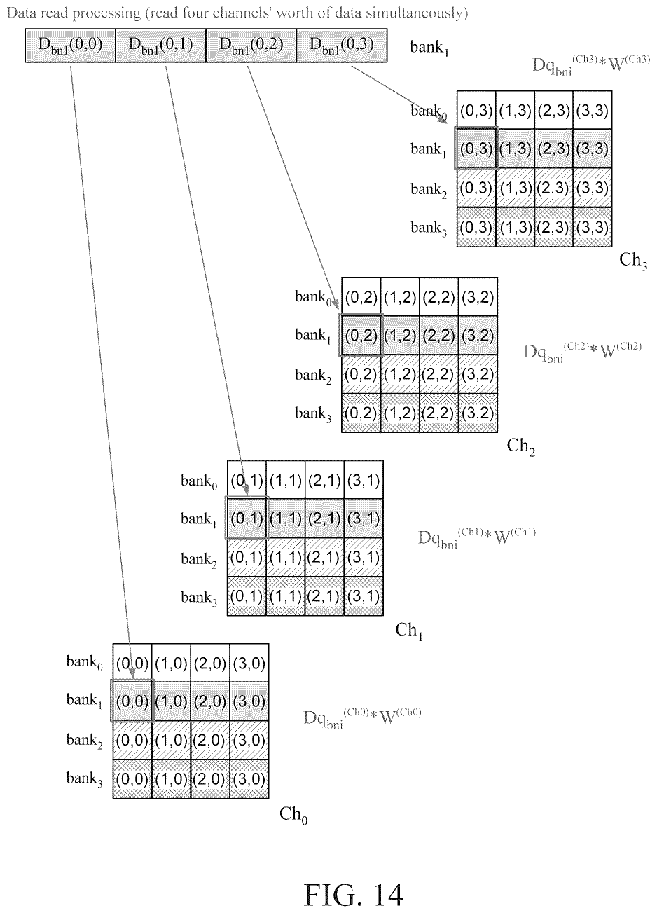

In step S111r_bnk_1, processing of reading data for the number of channels (Ch₀ to Ch_{N-1}) (N=4) from the bank memory bank₁ is performed. Specifically, the following processing is performed.
(2) During the period T₀ (the period from time t₀ to t₁), the memory access control unit 21 of the CNN data processing unit 2 outputs a control signal Ctl_r⁽¹⁾ to the bank memory Tmem_1 to instruct the memory unit 22 to read four pieces of data, D_{bn1}(0,0), D_{bn1}(0,1), D_{bn1}(0,2), and D_{bn1}(0,3) in parallel (using four access buses (see FIG. 5)) from consecutively addressed areas of the bank memory Tmem_1 (bank memory bank₁). In accordance with the control signal Ctl_r⁽¹⁾, the bank memory Tmem_1 of the memory unit 22 then reads out four pieces of data (four channels of data), namely, data D_{bn1}(0,0), D_{bn1}(0,1), D_{bn1}(0,2), and D_{bn1}(0,3) in parallel (using four access buses) from consecutively addressed areas of the bank memory Tmem_1 of the memory unit 22 (see FIG. 12) (see FIG. 14 for the relationship between the four channels of data read out in parallel and the spatial position of the feature data (feature map)).
   Step S111r_bnk_hre (hre=2):

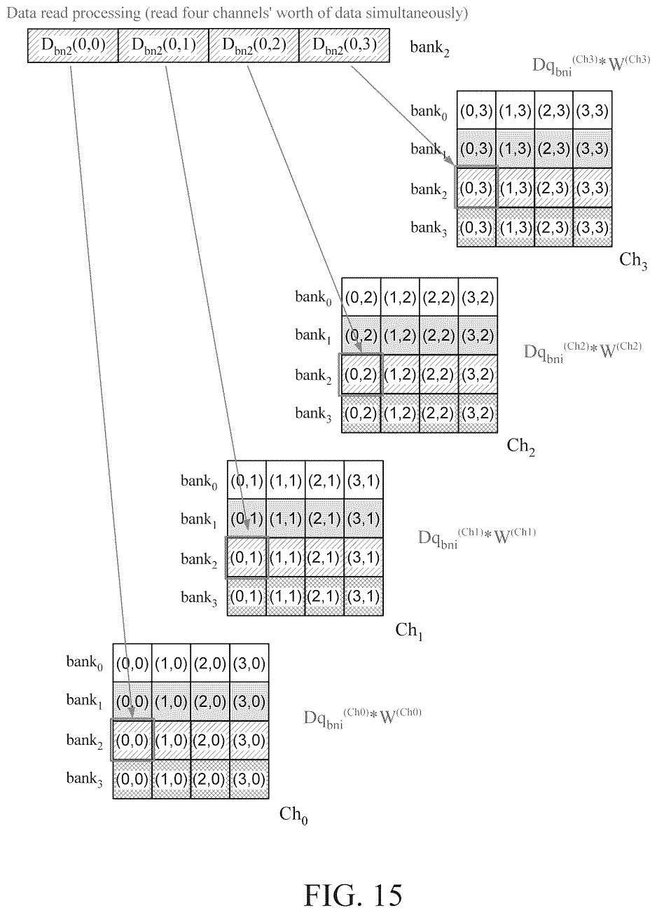

In step S111r_bnk_hre, processing of reading data for the number of channels (Ch₀ to Ch_{N-1}) (N=4) from the bank memory bankₕᵣₑ (bank memory Tmem_hre) (hre=2) is performed. Specifically, the following processing is performed.
(3) During the period T₀ (the period from time t₀ to t₁), the memory access control unit 21 of the CNN data processing unit 2 outputs a control signal Ctl_r⁽²⁾ to the bank memory Tmem_2 to instruct the memory unit 22 to read the four pieces of data D_{bn2}(0,0), D_{bn2}(0,1), D_{bn2}(0,2), and D_{bn2}(0,3) in parallel (using four access buses (see FIG. 5)) from consecutively addressed areas of the bank memory Tmem_2 (bank memory bank₂). In accordance with the control signal Ctl_r⁽²⁾, the bank memory Tmem_2 of the memory unit 22 then reads out four pieces of data (four channels of data), namely, data D_{bn2}(0,0), D_{bn2}(0,1), D_{bn2}(0,2), and D_{bn2}(0,3) in parallel (using four access buses) from consecutively addressed areas of the bank memory Tmem_2 of the memory unit 22 (see FIG. 12) (see FIG. 15 for the relationship between the four channels of data read out in parallel and the spatial position of the feature data (feature map).
   Steps S112r_bnk_hrs (hrs=0) to S112r_bnk_hre (hre=2):

In steps S112r_bnk_hrs (hrs=0) to S112r_bnk_hre (hre=2), processing for determining the number of output systems Num_sys is performed. As shown in FIGS. 6, 16, and 17, the data read out in the period T₀ is the data in the first column of block₀, and therefore does not contain any data in common (overlapping data) with other blocks (block₁ to block₅). Thus, in each of steps S112r_bnk_hrs (hrs=0) to S112r_bnk_hre (hre=2), the number of output systems Num_sys is determined as Num_sys=1.

Steps S113r_bnk_hrs (hrs=0) to S113r_bnk_hre (hre=2):

In steps S113r_bnk_hrs (hrs=0) to S113r_bnk_hre (hre=2), data sets of the number of output systems Num_sys (=1) are simultaneously outputted (register write processing is performed). Specifically, the following process is performed.

During the period T₀, the memory access control unit 21 of the CNN data processing unit 2 generates a control signal Ctl_r^{(k)} for reading data D_{bnk}(0,0) of the bank memory Tmem_k and then outputs the control signal Ctl_r^{(k)} to the bank memory Tmem_k, and also generates a control signal Ctl_reg that instructs the data D_{bnk}(0,0) of the bank memory Tmem_k to be written to an area at a predetermined address in the register unit 23, and then outputs the control signal Ctl_reg to the register unit 23. The bank memory Tmem_k reads out the data D_{bnk}(0,0) in accordance with the control signal Ctl_r^{(k)}, and the register unit 23 writes the data D_{bnk}(0,0) outputted from the bank memory Tmem_k to a predetermined address in accordance with the control signal Ctl_reg. Note that it is assumed that the predetermined address is designated by the control signal Ctl_reg.

During the period T₀, for data of channel 0 (Ch₀) and channel k (Chₖ) (1≤k≤3), the data outputted from the bank memory Tmem_k and the address of the register unit 23 to which the data is written are as follows:
<<Period T₀>> (Output to one system (Num_sys=1)) Channel 0 (Ch₀):
(1) Data D_{bn0}(0, 0) of the bank memory Tmem_0 (bank₀)
   Address adr00^{(Ch0)}of the register unit 23
(2) Data D_{bn1}(0,0) of the bank memory Tmem_1 (bank₁)
   Address adr03^{(Ch0)} of the register unit 23
(3) Data D_{bn2}(0,0) of the bank memory Tmem_2 (bank₂)
   Address adr06^{(Ch0)} of the register unit 23
      Channel k (Chₖ) (k is a Natural Number Satisfying 1≤k≤3):
(1) Data D_{bn0}(0, k) of the bank memory Tmem_0 (bank₀)
   Address adr00^{(Chk)} of the register unit 23
(2) Data D_{bn1}(0, k) of the bank memory Tmem_1 (bank₁)
   Address adr03^{(Chk)} of the register unit 23
(3) Data D_{bn2}(0, k) of the bank memory Tmem_2 (bank₂)
   Address adr06^{(Chk)} of the register unit 23

FIG. 18 shows the relationship between the above data (data of channel 0) and the write address of the register unit 23. As shown in FIG. 18, during period T0, data D_{bn0}(0,0), data D_{bn1}(0,0), and data D_{bn2}(0,0) are written to the areas of address adr00^{(Ch0)}, address adr03^{(Ch0)} (=address adr00^{(Ch0)}+3 addresses), and address adr06^{(Ch0)} (=address adr03^{(Ch0)}+3 addresses), respectively. In other words, during the period T0, data D_{bn0}(0,0), data D_{bn1}(0,0), and data D_{bn2}(0,0) are written to every third address of the register unit 23 (the bold rectangles in FIG. 18 indicate the data to be written). This is because the region (the kernel size) to be subjected to the convolution processing is 3×3, and thus, depending on the region (the kernel size), the 3×3 data is reshaped into 1×9 data to enable output to the quantized data memory unit 3. Note that it is assumed that the addresses adr00^{(Chk)} to adr08^{(Chk)} (k is a natural number satisfying 0≤k≤N−1) of the register unit 23 are consecutive addresses.

### Step S12r:

In step S12r, determination processing as to whether a predetermined amount of data has been outputted from the bank memory Tmem_k of the memory unit 22 to the register unit 23 is performed. At the end of the period T₀, all data in the region (kernel size) to be subjected to convolution processing has not been outputted from the bank memory Tmem_k of memory unit 22 to the register unit 23 (see the period T₀ in FIG. 18), so the process returns to step S11r.

### Step S1r (Period T1):

In step S1r, the CNN data processing unit 2 performs data read processing. For example, as shown in FIGS. 11 and 17, during the period T₁ (the period from time t₁ to time t₂), the following data is read from the memory unit 22 of the CNN data processing unit 2:
(1) Data D_{bn0}(1,0), D_{bn0}(1,1), D_{bn0}(1,2), D_{bn0}(1,3)
(2) Data D_{bn1}(1,0), D_{bn1}(1,1), D_{bn1}(1,2), D_{bn1}(1,3)
(3) Data D_{bn2}(1,0), D_{bn2}(1,1), D_{bn2}(1,2), D_{bn2}(1,3)
(Data D_{bnh}(i, j) indicates data for which the position in the width direction of channel Chⱼ is i and the position in the height direction is h.)

In this case, the CNN data processing unit 2 performs the following processing. In the above data, the position in the height direction h is 0 to 2, and thus the bank memory to be read is set to bank₀ to bank₂ (since the size of the kernel (weighting coefficient filter) for depthwise convolution (spatial convolution processing) is 3×3 and the height size is “3”, the configuration is set in this way). Thus, in the CNN data processing unit 2, the variable hrs (variable specifying the starting bank memory to be read out) and the variable hre (variable specifying the ending bank memory to be read out) that specify the bank memory to be read out are set to hrs=0 and hre=2 (hrs, hre: natural numbers, 0≤hrs≤M−1, 0≤hre≤M−1, hrs<hre) (step S110r).

Step S111r_bnk_hrs (hrs=0)):

In step S111r_bnk_hrs, processing of reading data for the number of channels (Ch₀ to Ch_{N-1}) (N=4) from the bank memory bankₕᵣₛ (bank memory Tmem_hrs) (hrs=0) is performed. Specifically, the following processing is performed.
(1) During the period T₁ (the period from time t₁ to time t₂), the memory access control unit 21 of the CNN data processing unit 2 outputs a control signal Ctl_r⁽⁰⁾ to the bank memory Tmem_0 to instruct the memory unit 22 to read four pieces of data, D_{bn0}(1,0), D_{bn0}(1,1), D_{bn0}(1,2), and D_{bn0}(1,3) in parallel (using four access buses (see FIG. 5)) from consecutive address areas of the bank memory Tmem_0 (bank memory bankₕᵣₛ, hrs−0). In accordance with the control signal Ctl_r⁽⁰⁾, the bank memory Tmem_0 of the memory unit 22 then reads out four pieces of data (four channels'worth of data), namely, data D_{bn0}(1,0), D_{bn0}(1,1), D_{bn0}(1,2), and D_{bn0}(1,3) in parallel (using four access buses) from areas of consecutive addresses in the bank memory Tmem_0 of the memory unit 22.

### Step S111r_bnk_1:

In step S111r_bnk_1, processing of reading data for the number of channels (Ch0 to ChN-1) (N=4) from the bank memory bank₁ is performed. Specifically, the following processing is performed.
(2) During the period T₁ (the period from time t₁ to t₂), the memory access control unit 21 of the CNN data processing unit 2 outputs a control signal Ctl_r⁽¹⁾ to the bank memory Tmem_1 to instruct the memory unit 22 to read four pieces of data, D_{bn1}(1,0), D_{bn1}(1,1), D_{bn1}(1,2), and D_{bn1}(1,3) in parallel (using four access buses (see FIG. 5)) from consecutively addressed areas of the bank memory Tmem_1 (bank memory bank₁). In accordance with the control signal Ctl_r⁽¹⁾, the bank memory Tmem_1 of the memory unit 22 then reads out four pieces of data (four channels' worth of data), namely, data D_{bn1}(1,0), D_{bn1}(1,1), D_{bn1}(1,2), and D_{bn1}(1,3) in parallel (using four access buses) from areas of consecutive addresses in the bank memory Tmem_1 of the memory unit 22.
   Step S111r_bnk_hre (hre=2):

In step S111r_bnk_hre, processing of reading data for the number of channels (Ch₀ to Ch_{N-1}) (N=4) from the bank memory bankₕᵣₑ (bank memory Tmem_hre) (hre=2) is performed. Specifically, the following processing is performed.
(3) During the period T₁ (the period from time t₁ to time t₂), the memory access control unit 21 of the CNN data processing unit 2 outputs a control signal Ctl_r⁽²⁾ to the bank memory Tmem_2 to instruct the memory unit 22 to read the four pieces of data D_{bn2}(1,0), D_{bn2}(1,1), D_{bn2}(1,2), and D_{bn2}(1,3) in parallel (using four access buses (see FIG. 5)) from consecutively addressed areas of the bank memory Tmem_2 (bank memory bank₂). In accordance with the control signal Ctl_r⁽²⁾, the bank memory Tmem_2 of the memory unit 22 then reads out four pieces of data (four channels'worth of data), namely, data D_{bn2}(1,0), D_{bn2}(1,1), D_{bn2}(1,2), and D_{bn2}(1,3) in parallel (using four access buses) from areas of consecutive addresses in the bank memory Tmem_2 of the memory unit 22.
   Steps S112r_bnk_hrs (hrs=0) to S112r_bnk_hre (hre=2):

In steps S112r_bnk_hrs (hrs=0) to S112r_bnk_hre (hre=2), processing for determining the number of output systems Num_sys is performed. As shown in FIGS. 6, 16, and 17, the data read out during the period T₁ is the data in the second column of block0 and the data in the first column of block₁. Thus, in each of steps S112r_bnk_hrs (hrs=0) to S112r_bnk_hre (hre=2), the number of output systems Num_sys is determined as Num_sys=2.

Steps S113r_bnk_hrs (hrs=0) to S113r_bnk_hre (hre=2):

In steps S113r_bnk_hrs (hrs=0) to S113r_bnk_hre (hre=2), data for the output system count Num_sys (=2) pairs is simultaneously outputted (register write processing is performed). Specifically, the following processing is performed.

During the period T₁, the memory access control unit 21 of the CNN data processing unit 2 generates a control signal Ctl_r^{(k)} for reading data D_{bnk}(1,0) of the bank memory Tmem_k and then outputs the control signal Ctl_r^{(k)} to the bank memory Tmem_k, and also generates a control signal Ctl_reg that instructs the data D_{bnk}(1,0) of the bank memory Tmem_k to be written to an area at a predetermined address in the register unit 23 and then outputs the control signal Ctl_reg to the register unit 23. The bank memory Tmem_k reads out the data D_{bnk}(1,0) in accordance with the control signal Ctl_r^{(k)}, and the register unit 23 writes the data D_{bnk}(1,0) outputted from the bank memory Tmem_k to a predetermined address in accordance with the control signal Ctl_reg. Note that it is assumed that the control signal Ctl_reg indicates the predetermined address.

During the period T₁, for data of channel 0 (Ch₀) and channel k (Chₖ) (1≤k≤3), the data outputted from the bank memory Tmem_k and the address of the register unit 23 to which the data is written are as follows.

<<Period T₁>>(Output to two Systems (Num_sys=2)) Channel 0 (Ch₀):
(1) Data D_{bn0}(1, 0) of the bank memory Tmem_0 (bank₀)
   Address adr01^{(Ch0)} of the register unit 23
   Address adr10^{(Ch0)} of the register unit 23
(2) Data D_{bn1}(1, 0) of the bank memory Tmem_1 (bank₁)
   Address adr04^{(Ch0)} of the register unit 23
   Address adr13^{(Ch0)} of the register unit 23
(3) Data D_{bn2}(1, 0) of the bank memory Tmem_2 (bank₂)
   Address adr07^{(Ch0)} of the register unit 23
   Address adr16^{(Ch0)} of the register unit 23
      Channel k (Chₖ) (k is a Natural Number Satisfying 1≤k≤3):
(1) Data D_{bn0}(1, k) of the bank memory Tmem_0 (bank₀)
   Address adr01^{(Chk)} of the register unit 23
   Address adr10^{(Chk)} of the register unit 23
(2) Data D_{bn1}(1, k) of the bank memory Tmem_1 (bank₁)
   Address adr04^{(Chk)} of the register unit 23
   Address adr13^{(Chk)} of the register unit 23
(3) Data D_{bn2}(1, k) of the bank memory Tmem_2 (bank₂)
   Address adr07^{(Chk)} of the register unit 23
   Address adr16^{(Chk)} of the register unit 23

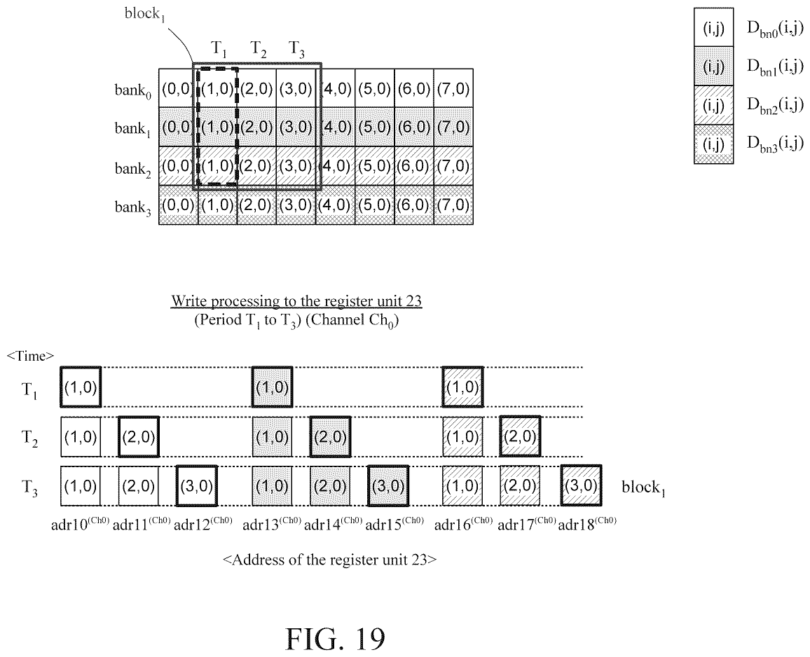

FIGS. 18 and 19 (part of the period T₁) show the relationship between the above data (data of channel 0) and the write address of the register unit 23.

As shown in FIG. 18, during the period T₁, data D_{bn0}(1,0), data D_{bn1}(1,0), and data D_{bn2}(1,0) are written to the areas of address adr01^{(Ch0)}, address adr04^{(Ch0)} (=address adr01^{(Ch0)}+3 addresses), and address adr07^{(Ch0)}(=address adr04^{(Ch0)}+3 addresses), respectively. In other words, during the period T1, data D_{bn0}(1,0), data D_{bn1}(1,0), and data D_{bn2}(1,0) are written to every third address of the register unit 23 (the bold rectangles in FIG. 18 indicate the data to be written). This is because the region (the kernel size) to be subjected to the convolution processing is 3×3, and thus, depending on the region (the kernel size), the 3×3 data is reshaped into 1×9 data to enable output to the quantized data memory unit 3.

Also, as shown in FIG. 19, during the period T₁, data D_{bn0}(1,0), data D_{bn1}(1,0), and data D_{bn2}(1,0) are written to the areas of address adr10^{(Ch0)}, address adr13^{(Ch0)}(=address adr10^{(Ch0)}+3 addresses), and address adr16^{(Ch0)}(=address adr13^{(Ch0)}+3 addresses), respectively. In other words, during the period T₁, data D_{bn0}(1,0), data D_{bn1}(1,0), and data D_{bn2}(1,0) are written to every third address of the register unit 23 (the bold rectangles in FIG. 19 indicate the data to be written). This is because the region (the kernel size) to be subjected to the convolution processing is 3×3, and thus, depending on the region (the kernel size), the 3×3 data is reshaped into 1×9 data to enable output to the quantized data memory unit 3. Note that it is assumed that the addresses adr10^{(Chk)} to adr18^{(Chk)} (k is a natural number satisfying 0≤k≤N−1) of the register unit 23 are consecutive addresses.

### Step S12r:

In step S12r, determination processing as to whether a predetermined amount of data has been outputted from the bank memory Tmem_k of the memory unit 22 to the register unit 23 is performed. At the end of the period T₁, all data in the region (the kernel size) to be subjected to the convolution processing has not been outputted from the bank memory Tmem_k of the memory unit 22 to the register unit 23 (see the period T₁ in FIG. 18 and the period T₁ in FIG. 19), and thus the process returns to step S11r.

### Step S1r (Period T2):

In step S1r, the CNN data processing unit 2 performs data read processing. For example, as shown in FIGS. 11 and 17, during the period T₂ (the period from time t₂ to time t₃), the following is read from the memory unit 22 of the CNN data processing unit 2.
(1) Data D_{bn0}(2,0), D_{bn0}(2,1), D_{bn0}(2,2), D_{bn0}(2,3)
(2) Data D_{bn1}(2,0), D_{bn1}(2,1), D_{bn1}(2,2), D_{bn1}(2,3)
(3) Data D_{bn2}(2,0), D_{bn2}(2,1), D_{bn2}(2,2), D_{bn2}(2,3)
(Data D_{bnh}(i, j) indicates data for which the position in the width direction of channel Chⱼ is i and the position in the height direction is h.)

In this case, the CNN data processing unit 2 performs the following processing. In the above data, the position in the height direction h is 0 to 2, so the bank memory to be read out is set to bank0 to bank2 (since the size of the kernel (weighting coefficient filter) for depthwise convolution (spatial convolution processing) is 3×3 and the height size is “3”, the configuration is set in this way). Thus, in the CNN data processing unit 2, the variable hrs (variable specifying the starting bank memory to be read out) and the variable hre (variable specifying the ending bank memory to be read out) that specify the bank memory to be read out are set to hrs=0 and hre=2 (hrs, hre: natural numbers, 0≤hrs≤M−1, 0≤hre≤M−1, hrs<hre) (step S110r).

Step S111r_bnk_hrs (hrs=0):

In step S111r_bnk_hrs, processing of reading data for the number of channels (Ch₀ to Ch_{N-1}) (N=4) from the bank memory bankₕᵣₛ (bank memory Tmem_hrs) (hrs=0) is performed. Specifically, the following processing is performed.
(1) During the period T₂ (the period from time t₂ to t₃), the memory access control unit 21 of the CNN data processing unit 2 outputs a control signal Ctl_r⁽⁰⁾ to the bank memory Tmem_0 to instruct the bank memory Tmem_0 to read four pieces of data D_{bn0}(2,0), D_{bn0}(2,1), D_{bn0}(2,2), and D_{bn0}(2,3) in parallel (using four access buses (see FIG. 5)) from consecutive address areas of the bank memory Tmem_0 (bank memory bankₕᵣₛ, hrs=0) of the memory unit 22. In accordance with the control signal Ctl_r⁽⁰⁾, the bank memory Tmem_0 of the memory unit 22 then reads out four pieces of data (four channels' worth of data), namely, data D_{bn0}(2,0), D_{bn0}(2,1), D_{bn0}(2,2), and D_{bn0}(2,3) in parallel (using four access buses) from areas of consecutive addresses in the bank memory Tmem_0 of the memory unit 22.

### Step S111r_bnk_1:

In step S111r_bnk_1, processing of reading data for the number of channels (Ch₀ to Ch_{N-1}) (N=4) from the bank memory bank1 is performed. Specifically, the following processing is performed.
(2) During the period T₂ (the period from time t₂ to t₃), the memory access control unit 21 of the CNN data processing unit 2 outputs a control signal Ctl_r⁽¹⁾ to the bank memory Tmem_1 to instruct the memory unit 22 to read the four pieces of data D_{bn1}(2,0), D_{bn1}(2,1), D_{bn1}(2,2), and D_{bn1}(2,3) in parallel (using four access buses (see FIG. 5)) from consecutively addressed areas of the bank memory Tmem_1 (bank memory bank1). In accordance with the control signal Ctl_r⁽¹⁾, the bank memory Tmem_1 of the memory unit 22 then reads out four pieces of data (four channels' worth of data), namely, data D_{bn1}(2,0), D_{bn1}(2,1), D_{bn1}(2,2), and D_{bn1}(2,3) in parallel (using four access buses) from areas of consecutive addresses in the bank memory Tmem_1 of the memory unit 22.
   Step S111r_bnk_hre (hre=2):

In step S111r_bnk_hre, processing of reading data for the number of channels (Ch₀ to Ch_{N-1}) (N=4) from the bank memory bankₕᵣₑ (bank memory Tmem_hre) (hre−2) is performed. Specifically, the following processing is performed.
(3) During the period T₂ (the period from time t₂ to t₃), the memory access control unit 21 of the CNN data processing unit 2 outputs a control signal Ctl_r⁽²⁾ to the bank memory Tmem_2 to instruct the memory unit 22 to read the four pieces of data D_{bn2}(2,0), D_{bn2}(2,1), D_{bn2}(2,2), and D_{bn2}(2,3) in parallel (using four access buses (see FIG. 5)) from consecutively addressed areas of the bank memory Tmem_2 (bank memory bank₂). In accordance with the control signal Ctl_r⁽²⁾, the bank memory Tmem_2 of the memory unit 22 then reads out four pieces of data (four channels' worth of data), namely, data D_{bn2}(2,0), D_{bn2}(2,1), D_{bn2}(2,2), and D_{bn2}(2,3) in parallel (using four access buses) from areas of consecutive addresses in the bank memory Tmem_2 of the memory unit 22.
   Steps S112r_bnk_hrs (hrs=0) to S112r_bnk_hre (hre=2):

In steps S112r_bnk_hrs (hrs=0) to S112r_bnk_hre (hre=2), processing for determining the number of output systems Num_sys is performed. As shown in FIGS. 6, 16, and 17, the data read out during the period T₂ is the data in the third column of block₀, the data in the second column of block₁, and the data in the first column of block₂. Thus, in each of steps S112r_bnk_hrs (hrs=0) to S112r_bnk_hre (hre=2), the number of output systems Num_sys is determined as Num_sys=3.

Steps S113r_bnk_hrs (hrs=0) to S113r_bnk_hre (hre=2):

In steps S113r_bnk_hrs (hrs=0) to S113r_bnk_hre (hre=2), data for the output system count Num_sys (=3) pairs are simultaneously outputted (register write processing is performed). Specifically, the following processing is performed.

During the period T₂, the memory access control unit 21 of the CNN data processing unit 2 generates a control signal Ctl_r^{(k)} for reading data D_{bnk}(2,0) of the bank memory Tmem_k and then outputs the control signal Ctl_r^{(k)} to the bank memory Tmem_k, and also generates a control signal Ctl_reg that instructs the data D_{bnk}(2,0) of the bank memory Tmem_k to be written to an area at a predetermined address in the register unit 23, and then outputs the control signal Ctl_reg to the register unit 23. The bank memory Tmem_k reads out the data D_{bnk}(2,0) in accordance with the control signal Ctl_r^{(k)}, and the register unit 23 writes the data D_{bnk}(2,0) outputted from the bank memory Tmem_k to a predetermined address in accordance with the control signal Ctl_reg. Note that it is assumed that the control signal Ctl_reg indicates the predetermined address.

During the period T₂, for data of channel 0 (Ch₀) and channel k (Chₖ) (1≤k≤3), the data outputted from the bank memory Tmem_k and the address of the register unit 23 to which the data is written are as follows.

<<Period T₂>>(Output to 3 systems (Num_sys=3)) Channel 0 (Ch₀):
(1) Data D_{bn0}(2, 0) of the bank memory Tmem_0 (bank₀)
   Address adr02^{(Ch0)} of the register unit 23
   Address adr11^{(Ch0)} of the register unit 23
   Address adr20^{(Ch0)} of the register unit 23
(2) Data D_{bn1}(2,0) of the bank memory Tmem_1 (bank₁)
   Address adr05^{(Ch0)} of the register unit 23
   Address adr14^{(Ch0)} of the register unit 23
   Address adr23^{(Ch0)} of the register unit 23
(3) Data D_{bn2}(2, 0) of the bank memory Tmem_2 (bank₂)
   Address adr08^{(Ch0)} of the register unit 23
   Address adr17^{(Ch0)} of the register unit 23
   Address adr26^{(Ch0)} of the register unit 23
      Channel k (Chₖ) (k is a natural number satisfying 1≤k≤3):
(1) Data D_{bn0}(2, k) of the bank memory Tmem_0 (bank₀)
   Address adr02^{(Chk)} of the register unit 23
   Address adr11^{(Chk)} of the register unit 23
   Address adr20^{(Chk)} of the register unit 23
(2) Data D_{bn1}(2, k) of the bank memory Tmem_1 (bank₁)
   Address adr05^{(Chk)} of the register unit 23
   Address adr14^{(Chk)} of the register unit 23
   Address adr23^{(Chk)} of the register unit 23
(3) Data D_{bn2}(2, k) of the bank memory Tmem_2 (bank₂)
   Address adr08^{(Chk)} of the register unit 23
   Address adr17^{(Chk)} of the register unit 23
   Address adr26^{(Chk)} of the register unit 23

FIGS. 18 to 20 (part of the period T₂) show the relationship between the above data (data of channel 0) and the write address of the register unit 23.

As shown in FIG. 18, during the period T₂, data D_{bn0}(2,0), data D_{bn1}(2,0), and data D_{bn2}(2,0) are written to the areas of address adr02^{(Ch0)}, address adr05^{(Ch0)} (=address adr02^{(Ch0)}+3 addresses), and address adr08^{Ch0}(=address adr05^{(Ch0)}+3 addresses), respectively. In other words, during the period T₂, data D_{bn0}(2,0), data D_{bn1}(2,0), and data D_{bn2}(2,0) are written to every third address of the register unit 23 (the bold rectangles in FIG. 18 indicate the data to be written). This is because the region (the kernel size) to be subjected to the convolution processing is 3×3, and thus, depending on the region (the kernel size), the 3×3 data is reshaped into 1×9 data to enable output to the quantized data memory unit 3.

Also, as shown in FIG. 19, during the period T₂, data D_{bn0}(2,0), data D_{bn1}(2,0), and data D_{bn2}(2,0) are written to the areas of address adr11^{(Ch0)}, address adr14^{(Ch0)} (=address adr11^{(Ch0)}+3 addresses), and address adr17^{(Ch0)} (=address adr14^{(Ch0)}+3 addresses), respectively. In other words, during the period T₂, data D_{bn0}(2,0), data D_{bn1}(2,0), and data D_{bn2}(2,0) are written to every third address of the register unit 23 (the bold rectangles in FIG. 19 indicate the data to be written). This is because the region (the kernel size) to be subjected to the convolution processing is 3×3, and thus, depending on the region (the kernel size), the 3×3 data is reshaped into 1×9 data to enable output to the quantized data memory unit 3.

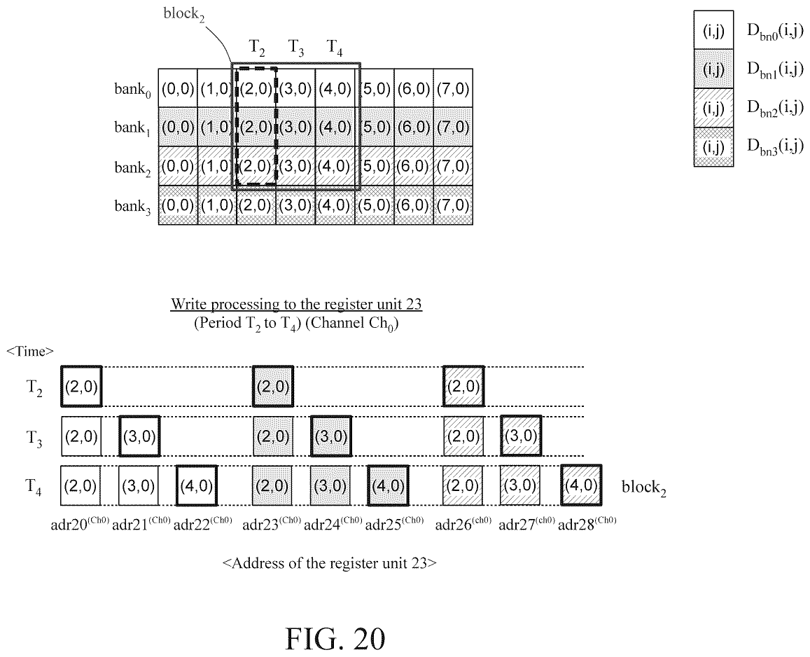

Also, as shown in FIG. 20, during the period T₂, data D_{bn0}(2,0), data D_{bn1}(2,0), and data D_{bn2}(2,0) are written to the areas of address adr20^{(Ch0)}, address adr23^{(Ch0)} (=address adr20^{(Ch0)}+3 addresses), and address adr26^{(Ch0)} (=address adr23^{(Ch0)}+3 addresses), respectively. In other words, during the period T₂, data D_{bn0}(2,0), data D_{bn1}(2,0), and data D_{bn2}(2,0) are written to every third address of the register unit 23 (the bold rectangles in FIG. 20 indicate the data to be written). This is because the region (the kernel size) to be subjected to the convolution processing is 3×3, and thus, depending on the region (the kernel size), the 3×3 data is reshaped into 1×9 data to enable output to the quantized data memory unit 3. Note that it is assumed that the addresses adr20^{(Chk)} to adr28^{(Chk)} (k is a natural number satisfying 0≤k≤N-1) of the register unit 23 are consecutive addresses.

### Step S12r:

In step S12r, determination processing as to whether a predetermined amount of data has been outputted from the bank memory Tmem_k of the memory unit 22 to the register unit 23 is performed. At the end of the period T₂, as shown in FIG. 18, all data in the region (kernel size) to be subjected to convolution processing for block₀ has been outputted from the bank memory Tmem_k of the memory unit 22 to the register unit 23 (see the period T₂ in FIG. 18), and thus the process proceeds to step S13r.

### Step S13r:

In step S13r, register output processing is performed. Specifically, for the block₀, all data in the region (the kernel size) to be subjected to convolution processing has been outputted from the bank memory Tmem_k of the memory unit 22 to the register unit 23, and thus the register unit 23 outputs data including the following data as data D2 to the quantized data memory unit 3.

<<Feature Data (Quantized Data) (Block₀) (Ch₀)>>(Period T₂)
Data D_{bn0}(0,0), Data D_{bn0}(1,0), Data D_{bn0}(2,0)
Data D_{bn1}(0,0), Data D_{bn1}(1,0), Data D_{bn1}(2,0)
Data D_{bn2}(0,0), Data D_{bn2}(1,0), Data D_{bn2}(2,0)

(The above data is stored in consecutive address areas (adr00^{(Ch0)} to adr08^{(Ch0)} of the register unit 23 (See FIG. 21).

<<Feature Data (Quantized Data) (Block₀) (Ch₁)>>(period T₂)
Data D_{bn0}(0,1), Data D_{bn0}(1,1), Data D_{bn0}(2,1)
Data D_{bn1}(0,1), Data D_{bn1}(1,1), Data D_{bn1}(2,1)
Data D_{bn2}(0,1), Data D_{bn2}(1,1), Data D_{bn2}(2,1)

(The above data is stored in consecutive address areas (adr00^{(Ch1)} to adr08^{(Ch1)} of the register unit 23.

<<Feature Data (Quantized Data) (Block₀) (Ch₂)>(Period T₂)
Data D_{bn0}(0,2), Data D_{bn0}(1,2), Data D_{bn0}(2,2)
Data D_{bn1}(0,2), Data D_{bn1}(1,2), Data D_{bn1}(2,2)
Data D_{bn2}(0,2), Data D_{bn2}(1,2), Data D_{bn2}(2,2)

(The above data is stored in consecutive address areas (adr00^{(Ch2)} to adr08^{(Ch2)} of the register unit 23.

<<Feature Data (Quantized Data) (Block₀) (Ch₃)>>(Period T₂)
Data D_{bn0}(0,3), Data D_{bn0}(1,3), Data D_{bn0}(2,3)
Data D_{bn1}(0,3), Data D_{bn1}(1,3), Data D_{bn1}(2,3)
Data D_{bn2}(0,3), Data D_{bn2}(1,3), Data D_{bn2}(2,3)

(The above data is stored in consecutive address areas (adr00^{(Ch3)} to adr08^{(Ch3)} of the register unit 23.

### Step S2r:

In step S2r, it is determined whether or not data to be subjected to read processing by the CNN data processing unit 2; if data to be subjected to read processing remains, the process returns to step S11r and the same process as above is performed. On the other hand, if no data to be processed remains, the data reading processing by the CNN data processing unit 2 ends.

When data to be processed remains, the CNN data processing unit 2 performs the same processing as that performed in the above-described period T₂ for the processing in the period T₃.

During the processing for the period T₃, register output processing is performed in step S13r; since all data for the region (the kernel size) to be subjected to convolution processing for the block 1 has been outputted from the bank memory Tmem_k of memory unit 22 to the register unit 23, the register unit 23 outputs data including the following data as data D2 to the quantized data memory unit 3.

<<Feature Data (Quantized Data) (Block₁) (Ch₀)>>(Period T₃)
Data D_{bn0}(1,0), Data D_{bn0}(2,0), Data D_{bn0}(3,0)
Data D_{bn1}(1,0), Data D_{bn1}(2,0), Data D_{bn1}(3,0)
Data D_{bn2}(1,0), Data D_{bn2}(2,0), Data D_{bn2}(3,0)

(The above data is stored in consecutive address areas (adr10^{(Ch0)} to adr18^{(Ch0)} ) of the register unit 23 (See FIG. 21).

<<Feature Data (Quantized Data) (Block₁) (Ch₁)>>(Period T₃)
Data D_{bn0}(1,1), Data D_{bn0}(2,1), Data D_{bn0}(3,1)
Data D_{bn1}(1,1), Data D_{bn1}(2,1), Data D_{bn1}(3,1)
Data D_{bn2}(1,1), Data D_{bn2}(2,1), Data D_{bn2}(3,1)

(The above data is stored in consecutive address areas (adr10^{(Ch1)} to adr18^{(Ch1)} ) of the register unit 23.

<<Feature Data (Quantized Data) (Block₁) (Ch₂)>>(Period T₃)
Data D_{bn0}(1,2), Data D_{bn0}(2,2), Data D_{bn0}(3,2)
Data D_{bn1}(1,2), Data D_{bn1}(2,2), Data D_{bn1}(3,2)
Data D_{bn2}(1,2), Data D_{bn2}(2,2), Data D_{bn2}(3,2)

(The above data is stored in consecutive address areas (adr10^{(Ch2)} to adr18^{(Ch2)} ) of the register unit 23.)

<<Feature Data (Quantized Data) (Block₁) (Ch₃)>>(Period T₃)
Data D_{bn0}(1,3), Data D_{bn0}(2,3), Data D_{bn0}(3,3)
Data D_{bn1}(1,3), Data D_{bn1}(2,3), Data D_{bn1}(3,3)
Data D_{bn2}(1,3), Data D_{bn2}(2,3), Data D_{bn2}(3,3)

(The above data is stored in consecutive address areas (adr10^{(Ch3)} to adr18^{(Ch3)} ) of the register unit 23.

The CNN data processing unit 2 similarly performs the processing from the period T4 onwards, and ends the processing when no data to be processed remains.

The quantized data memory unit 3 receives the data D2 outputted from the register unit 23 of the CNN data processing unit 2 and stores the data D2. The data D2 outputted from the register unit 23 of the CNN data processing unit 2 is data in which 3×3 data has been reshaped into 1×9 data according to the region to be subjected to the convolution processing (kernel size (3×3 in the present embodiment)), and therefore the quantized data memory unit 3 stores the data D2, for example, in an area of consecutive addresses.

The convolution processing unit 4 reads out, from the quantized data memory unit 3, data of the region to be subjected to convolution processing using the received weighting coefficient data Din_w (weighting filter (kernel)). The convolution processing unit 4 then performs convolution processing (convolution operation) on the data read out from the quantized data memory unit 3 using the weighting coefficient data Din_w (3×3 kernel in the present embodiment), obtains the data after convolution processing, and then outputs the obtained data as data Dout.

### SUMMARY OF THE EMBODIMENT

As described above, in the CNN data processing device 100, the CNN data processing unit 2 can perform in parallel the data writing processing of the data outputted from the quantization processing unit 1 (quantized data of feature data) to the memory unit 22 and the data reading processing from the memory unit 22; furthermore, the memory unit 22 has multiple bank memories Tmem_k, and can write and/or read multiple pieces of data simultaneously (in parallel). This allows the CNN data processing device 100 to achieve high-speed data writing and reading processing. In the CNN data processing device 100, (1) each of the multiple bank memories Tmem_k of the memory unit 22 is provided with multiple access buses, allowing simultaneous (parallel) access to data for multiple channels, and (2) different (independent) bank memories Tmem_k are assigned to each height direction of the region to be subjected to convolution processing (the region to be convolved with the kernel), allowing simultaneous (parallel) access to multiple data in different height directions. Thus, in the CNN data processing device 100, during one data read processing period (period Tᵢ), data of h×1 (h rows, 1 column, h: position in the height direction) of the region to be subjected to the convolution processing can be read out for multiple channels.

Further, the CNN data processing device 100 obtains the number of output systems Num_sys, which is the number of overlapping data sets (h×1 data sets in the region to be subjected to convolution processing) according to the position of the region to be subjected to convolution processing (slid position), and then outputs the overlapping data sets (h×1 data sets in the region to be subjected to convolution processing) equal to the obtained number of output systems Num_sys to the register unit 23, each in a separate system (in parallel).

This allows the CNN data processing device 100 to slide the position of the region to be subjected to convolution processing, thereby reducing the number of times overlapping data is read.

The CNN data processing device 100 also includes the register unit 23, in which data read from the memory unit 22 is written to discrete addresses (addresses to which a predetermined offset value (corresponding to the size of the kernel in the width direction (in the case of a 3×3 kernel, the offset value is “3”)) is added) according to the size (shape) of the region to be convolution processed (size (shape) of the kernel), and after all data of the region to be convolution processed (quantized data of feature data) has been collected (after all data of the region to be convolution processed has been written at consecutive addresses in the register unit 23), all data of the region to be convolution processed is outputted to the quantized data memory unit 3.

This allows the CNN data processing device 100 to output all data in the region to be convolution processed (data to be subjected to convolution processing) as data arranged in the order in which the convolution operation is to be performed, and then write it to the quantized data memory unit 3. The data arranged in the order in which the convolution operation is to be performed is read from the quantized data memory unit 3, and the convolution processing unit 4 performs convolution processing using the kernel weighting coefficient data to be applied to the data, thereby allowing the convolution processing to be performed at high speed.

In this way, in the CNN data processing device 100, simply providing the CNN data processing unit 2 allows for reducing the number of times that duplicate data is read, while obtaining data arranged in the order in which convolution operations are performed. Thus, the CNN data processing device 100 can perform data processing to achieve a high-performance, high-speed CNN model, which can reduce the number of times the process of reading feature data is performed and shorten the time required for the entire convolution processing including the processing of reading feature data.

### Other Embodiments

In the above embodiment, a case has been described in which weighting coefficient data Din_w (weight filter (kernel)) is inputted to the convolution processing unit 4 in the CNN data processing device 100, and convolution processing is performed using the weighting coefficient data Din_w (weight filter (kernel)); however, the present invention should not be limited to this. For example, the convolution processing unit 4 may perform vector decomposition processing on the weighting filter (kernel) to decompose it into a basis matrix and a real coefficient vector, and the decomposed basis matrix and real coefficient vector may be inputted to perform convolution processing. In such a case, convolution processing is performed using a basis matrix (a matrix whose elements are only basis values (integer values)) and data D3 outputted from the quantized data memory unit 3, and then processing is performed using real coefficient vectors, so that most of the convolution operations can be integer operations, thus allowing for performing the convolution processing at an even faster speed.

In the above embodiment, the CNN data processing device 100 has been described as using a kernel of a predetermined size (3×3) and a region to be subjected to convolution processing having a size of 4×8; however, the present invention should not be limited to this, and the size of the kernel and the size of the region to be subjected to convolution processing may be different sizes.

In the above embodiment, the CNN data processing device 100 has been described assuming that CNN data processing is performed using depthwise convolution (convolution processing in the spatial direction), but the present invention should not be limited to this. In the CNN data processing device 100, for example, the CNN data processing of the above embodiment may be applied to normal convolution processing.

Further, in the above embodiment, the case where the CNN data processing device 100 performs CNN data processing on data after quantization processing (quantized data) has been described, but the present invention should not be limited to this. For example, data (feature data) that has not been subjected to quantization processing may be inputted to the CNN data processing unit 2 of the CNN data processing device 100, and the CNN data processing unit 2 may perform CNN data processing on the data.

Further, the configuration of the memory unit 22 of the CNN data processing device 100 should not be limited to that described in the above embodiment, and the number of bank memories and the number of pieces of data that can be simultaneously accessed from each bank memory (number of access buses) can be set to any number.

Each block of the CNN data processing device 100 described in the above embodiment may be formed using a single chip with a semiconductor device, such as LSI, or some or all of the blocks of the CNN data processing device 100 may be formed using a single chip. Further, each block (each functional unit) of the CNN data processing device 100 described in the above embodiments may be implemented with a semiconductor device such as a plurality of LSIs.

Note that the LSI described here may also be referred to as an IC, a system LSI, a super LSI, or an ultra LSI, depending on the degree of integration.

Further, the method of circuit integration should not be limited to LSI, and it may be implemented with a dedicated circuit or a general-purpose processor. A field programmable gate array (FPGA) that can be programmed after the LSI is manufactured, or a reconfigurable processor that can reconfigure connection and setting of circuit cells inside the LSI may be used.

Further, a part or all of the processing of each functional block of each of the above embodiments may be implemented with a program. A part or all of the processing of each functional block of each of the above-described embodiments is then performed by a central processing unit (CPU) in a computer. The programs for these processes may be stored in a storage device, such as a hard disk or a ROM, and may be executed from the ROM or be read into a RAM and then executed.

The processes described in the above embodiments may be implemented by using either hardware or software (including use of an operating system (OS), middleware, or a predetermined library), or may be implemented using both software and hardware.

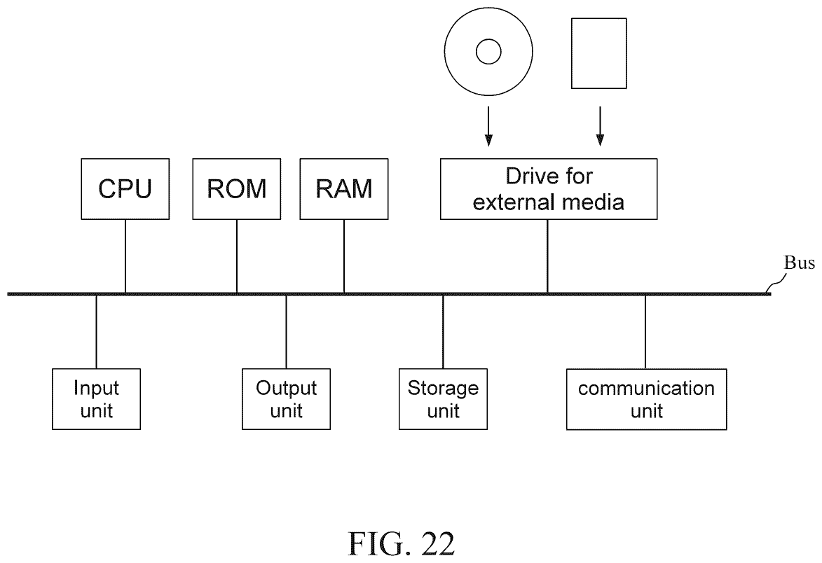

For example, when each functional unit of the above embodiment is achieved by using software, the hardware structure (the hardware structure including CPU(s), GPU(s), ROM, RAM, an input unit, an output unit, or the like, each of which is connected to a bus) shown in FIG. 22 may be employed to achieve the functional units by using software.

When each functional unit of the above embodiment is achieved by using software, the software may be achieved by using a single computer having the hardware configuration shown in FIG. 22, and may be achieved by using distributed processes using a plurality of computers.

The processes described in the above embodiment may not be performed in the order specified in the above embodiment. The order in which the processes are performed may be changed without departing from the scope and the spirit of the invention. Further, in the processing method in the above-described embodiment, some steps may be performed in parallel with other steps without departing from the scope and the spirit of the invention. In addition, in the processing method in the above embodiment, the processing performed in parallel may be performed in series (sequentially).

The present invention may also include a computer program enabling a computer to implement the method described in the above embodiments and a computer readable recording medium on which such a program is recorded. Examples of the computer readable recording medium include a flexible disk, a hard disk, a CD-ROM, an MO, a DVD, a DVD-ROM, a DVD-RAM, a large capacity DVD, a next-generation DVD, and a semiconductor memory.

The computer program may not be recorded on the recording medium but may be transmitted with an electric communication line, a wireless or wired communication line, or a network such as the Internet.

The term “unit” may include “circuitry,” which may be partly or entirely implemented by using either hardware or software, or both hardware and software.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

The specific structures described in the above embodiment are mere examples of the present invention, and may be changed and modified variously without departing from the scope and the spirit of the invention.

### REFERENCE SIGNS LIST

100 CNN data processing device
2 CNN data processing unit (convolution processing data device)
21 Memory access control unit (access control unit)
22 Memory unit
Tmem_0 to Tmem_M-1 Bank memory
23 Register unit

What is claimed is:

1. A data processing device for convolution processing used in a convolutional neural network model, comprising:
a plurality of bank memories for storing feature data; and
access control circuitry that controls data writing and/or data reading of the plurality of bank memories;
wherein the feature data is three-dimensional data specified by a position in a width direction, a position in a height direction, and a position in a channel direction,
each of the plurality of bank memories has a plurality of access buses so as to be able to access data in parallel, and
the access control circuitry performs data write control so that the feature data whose position in the height direction is a first value is stored in a bank memory allocated to the first value among the plurality of bank memories, and further stores the plurality of feature data having the same position in the width direction and consecutive positions in the channel direction in memory areas at addresses accessible in parallel via the plurality of buses.

2. The data processing device for convolution processing according to claim 1,
wherein the access control circuitry performs data read control on the plurality of bank memories so that the feature data having the same position in the width direction and consecutive positions in the height direction are read for a plurality of channels in a read unit period.

3. The data processing device for convolution processing according to claim 1,
wherein assuming that a data group obtained by reading the feature data, which are at the same position in the width direction and have consecutive positions in the height direction, for a plurality of channels from the plurality of bank memories is a multi-channel h×1 data group, the access control circuitry obtains the number of overlapping multi-channel h×1 data groups as the number of output systems in the same read unit period depending on the position of the region to be subjected to convolution processing, and controls the multiple bank memories so that the multiple channel h×1 data groups equal to the obtained number of output systems are outputted from the multiple bank memories.

4. The data processing device for convolution processing according to claim 3, further comprising register circuitry capable of storing data by addressing,
wherein the register circuitry inputs the multi-channel h×1 data group outputted from the multiple bank memories, uses a size in the width direction of the kernel of the convolution processing to be performed on the multi-channel h×1 data group as an offset value, and sequentially writes feature data, which are located at consecutive positions in the height direction and are included in the multi-channel h×1 data group, into the memory area of the register circuitry at an address offset by the offset value.

5. A data processing device for convolution processing according to claim 4,
wherein, after the feature data of the region to be subjected to convolution processing with the kernel is stored in the memory area of the register circuitry at consecutive addresses, the register circuitry outputs the feature data stored in the memory area at the consecutive addresses.

6. The data processing device for convolution processing according to claim 5,
wherein the register circuitry outputs the feature data stored in the memory area of the consecutive addresses all at once or in the order of the consecutive addresses.
